(19) United States
(12) Patent Application Publication
(10) Pub. No.: US 2026/0367888 A1
(43) Pub. Date: Nov. 19, 2026

(54) AUTOMATED SOFTWARE DEVELOPMENT ENVIRONMENT WITH GENERATIVE RESPONSE ENGINE

(71) Applicant: OpenAI OpCo, LLC, San Francisco, CA (US)

(72) Inventors: Alexander Embiricos, San Francisco, CA (US); David Kjelkerud, San Francisco, CA (US); Kevin Tunc, Berkeley, CA (US)

(73) Assignee: OpenAI OpCo, LLC, San Francisco, CA (US)

(21) Appl. No.: 19/351,746

(22) Filed: Oct. 7, 2025

Related U.S. Application Data
(60) Provisional application No. 63/806,537, filed on May 15, 2025.

(51) Int. Cl. G06F 8/35; G06F 8/33; G06F 8/36

(52) U.S. Cl. CPC G06F 8/35; G06F 8/33; G06F 8/36

(57) ABSTRACT

Systems and techniques are described herein for automating software development. For example, an apparatus is configured to: obtain data from a terminal interface of a container after an AI model has provided a first instruction to the container, wherein the first instruction is associated with an agentic software development task; generate a terminal emulator state of a terminal emulator at a discrete time based on the data, wherein the data illustrates input and output of the container over a duration of time; and provide the terminal emulator state to the AI model in connection with the agentic software development task.

### CROSS REFERENCE TO RELATED APPLICATIONS

This application claims the benefit of U.S. provisional application number 63/806,537, filed on May 15, 2025, entitled AUTOMATED SOFTWARE DEVELOPMENT WITH GENERATIVE RESPONSE ENGINE, which is expressly incorporated by reference herein in its entirety.

### BACKGROUND

Generative response engines such as large language models represent a significant milestone in the field of artificial intelligence, revolutionizing computer-based natural language understanding and generation. Generative response engines, powered by advanced deep learning techniques, have demonstrated astonishing capabilities in tasks such as text generation, translation, summarization, and even code generation. Generative response engines can sift through vast amounts of text data, extract context, and provide coherent responses to a wide array of queries.

### BRIEF DESCRIPTION OF THE SEVERAL VIEWS OF THE DRAWINGS

Details of one or more aspects of the subject matter described in this disclosure are set forth in the accompanying drawings and the description below. However, the accompanying drawings illustrate only some typical aspects of this disclosure and are therefore not to be considered limiting of its scope. Other features, aspects, and advantages will become apparent from the description, the drawings, and the claims.

FIG. 1 illustrates an example system supporting a generative response engine during inference operations in accordance with some aspects of the disclosure.

FIG. 2 is a conceptual block diagram of an automated software development system using a generative response engine in accordance with some aspects of the disclosure.

FIG. 3 is a flowchart illustrating a runtime process of a terminal service to interface with an AI model in accordance with some aspects of the disclosure.

FIG. 4 is a sequence diagram illustrating an automated software development process that integrates with a conventional software development process in accordance with some aspects of the disclosure.

FIGS. 5A-5L illustrate various screens and states of a user interface associated with an automated software development system in accordance with some aspects of the disclosure.

FIG. 6 illustrates a flowchart of process for interfacing with a terminal in an agentic software development process.

FIG. 7 illustrates a flowchart of process for interfacing with a terminal in an agentic software development process.

FIG. 8 is a block diagram illustrating an example machine-learning platform in accordance with some aspects of the disclosure.

FIG. 9A, FIG. 9B, and FIG. 9C illustrate an example transformer architecture in accordance with some aspects of the disclosure.

FIG. 10 shows an example of a system for implementing some aspects of the present technology.

### DETAILED DESCRIPTION

Generative response engines such as large language models represent a significant milestone in the field of artificial intelligence, revolutionizing computer-based natural language understanding and generation. Generative response engines, powered by advanced deep learning techniques, have demonstrated astonishing capabilities in tasks such as text generation, translation, summarization, and even code generation.

Many generative response engines provide a conversational user interface powered by a chatbot whereby the user account interacts with the generative response engine through natural language conversation with the chatbot. Such a user interface provides an intuitive format to provide prompts or instructions to the generative response engine.

One use of generative response engines is automated application development and software development functions to automate complex tasks, enhance productivity, and reduce manual errors. For example, generative response engines are driven by advanced artificial (AI) models and can interpret natural language specifications or high-level requirements and generate corresponding code, documentation, or configurations, which allows developers to focus more on architectural decisions and problem-solving rather than repetitive implementation details. As an example, a function that translates user stories into unit tests or skeleton code is important because it accelerates the development phase and also enforces consistency and test coverage from the outset. A generative response engine can also automate the creation and maintenance of CI/CD pipelines by writing instructions (e.g., YAML or JSON) files for workflows, and generating server deployment scripts tailored to specific cloud environments. Additionally, generative response engines can automate tasks such as database schema migrations, application programming interface (API) endpoint scaffolding, and server provisioning to streamline operations and reduce friction between development and operations teams. Generative response engines can contribute to documentation, generate performance monitoring scripts, and produce security checks. Despite these advantages, generative response engines require thorough oversight, including human review of generated code, robust automated testing, and continuous feedback loops to ensure maintainability, security, and scalability.

There are various types of AI-based software development techniques, such as extensions for a development environment, prompt-based code generation in a console or a chat application (e.g., CHATGPT), web-app development environments, and autonomous agenting using a command-line interface (CLI), code translation/migration tools, and visual-to-code generators for converting images to markup/layout.

Extensions for development environments (e.g., for VS Code, JetBrains, or even cloud environments like CodeSandbox) integrate the AI directly into the user's workspace, effectively embedding the AI within the coding environment itself. This tight integration allows the AI to access the active file system, interpret the full project context, and directly write, edit, or refactor code in real time. Rather than acting as a separate assistant or chat interface, the AI becomes a seamless part of the development loop and can offer suggestions, generate functions, fix bugs, or even scaffold entire files into the user's workspace. In many cases, these tools can also access the command-line interface (CLI) to run build tools, tests, or install dependencies. However, this level of access introduces potential security risks because malicious or poorly validated AI-generated commands could alter system files, expose credentials, or install unsafe packages.

Online development environments (e.g., CODESANDBOX, STACKBLITZ, etc.) provide an effective sandboxed environment for rapid prototyping and isolated code execution, and can even integrate with some AI-based models. The development environments may spin up lightweight containers with predefined runtimes and allow users to experiment with AI-generated code safely and without affecting their local systems. However, because these environments do not mirror the user's actual development setup (e.g., local dependencies, environment variables, file structures, or system-level configurations), code generated or tested in the sandbox may not behave identically when merged into the real project. This discrepancy can lead to integration issues, unexpected bugs, or environment-specific failures, especially in complex applications that rely on custom tooling, build systems, or native modules.

In online development environments that integrate AI models as a service, the development experience can become disjointed due to shifting views and dynamically changing interfaces. As the model responds to prompts, generates code, or suggests edits, the interface may transition between input prompts, code output, terminal logs, and contextual explanations. This constant movement can disrupt a developer's focus and make it difficult to follow the flow of actions or understand the actions the model is performing. Without a stable, predictable interface or persistent visual context, developers may struggle to grasp how the AI fits into their workflow, leading to confusion or hesitation when integrating generated code into the broader project.

Systems, apparatuses, processes (also referred to as methods), and computer-readable media (collectively referred to as “systems and techniques”) are described herein for initiating and managing agentic software development tasks using a front end application configured to interact with a computing service. In some aspects, a first view of the application includes a prompt editor configured to receive a natural language instruction and one or more components for selecting a code repository and an associated branch. Upon receiving the natural language instruction, the front end application transmits the instruction and information pertaining to the code repository to the computing service, thereby initiating a first agentic software development task. The first view also includes a task list that is updated to include the new task and its current status, with updates being performed without refreshing the view so that user state and context are preserved.

In some aspects, the first view maintains continuity of operation by updating the displayed DOM tree to reflect task status changes instead of triggering a full-page refresh. This enables the user to initiate new tasks or review previous agentic software development tasks—including tasks that are still active—while retaining the current view state. Previous tasks in the task list may include active development operations that an AI model is performing concurrently with the receipt of new instructions. The transmitted repository information can also include secure access credentials, such as a secret key, enabling the computing service to interact with private code repositories. Once the computing service completes the first agentic software development task, the task list is updated to reflect its completion, again without refreshing the view, ensuring a seamless and responsive user experience.

In some aspects, the front end application may display a second view containing a summary of the completed agentic software development task, including a diff of changes to one or more files and a log of actions taken to satisfy the natural language instruction. Both the first view and the second view can include the same prompt editor for continuous task input, enabling additional agentic tasks to be initiated without view refresh. The prompt editor may further provide distinct input modes for generating code or for returning an answer based on the results of a completed development task. In certain implementations, the front end application may also receive and display development data generated by the AI model—such as an inner monologue describing sub-tasks, diffs of modified files, and executed commands—and allow the user to annotate this development data with comments. These comments, along with new natural language instructions, may be transmitted back to the computing service to initiate new tasks or respond to questions, supporting iterative, interactive, and context-rich software development workflows.

Systems, apparatuses, processes (also referred to as methods), and computer-readable media (collectively referred to as “systems and techniques”) are described herein for generating and operating a containerized development environment that mirrors, as closely as possible, the development environment of a user. In some aspects, a computing service generates a container environment based on a code repository, and the container includes a cloned version of the repository and is configured with operating system, runtime, tooling, and dependency configurations that match the user's development setup. The mirror environment ensures consistent behavior between local and containerized workflows, enabling development practices and testing outcomes to remain uniform across environments. Once configured, the computing service provides an agentic software development task to an AI model, which operates within the container to modify the cloned version of the code repository while adhering to the same conventions, libraries, and environment settings as the user's local workspace.

In some aspects, the AI model streams an inner monologue to the front end application while executing the agentic software development task. The inner monologue identifies discrete actions being performed, such as locating relevant files, applying specific code changes, running tests, or adjusting configuration files. This streamed reasoning provides visibility into the AI model's decision-making process and allows the user to monitor task progress in real time. Upon completion of the agentic software development task, the computing service retrieves the modified version of the code repository from the container. Because the containerized environment closely mirrors the user's (or a development team's) setup, the resulting code modifications are more likely to integrate smoothly into the user's workflow, reinforcing consistent development practices and minimizing environment-related discrepancies.

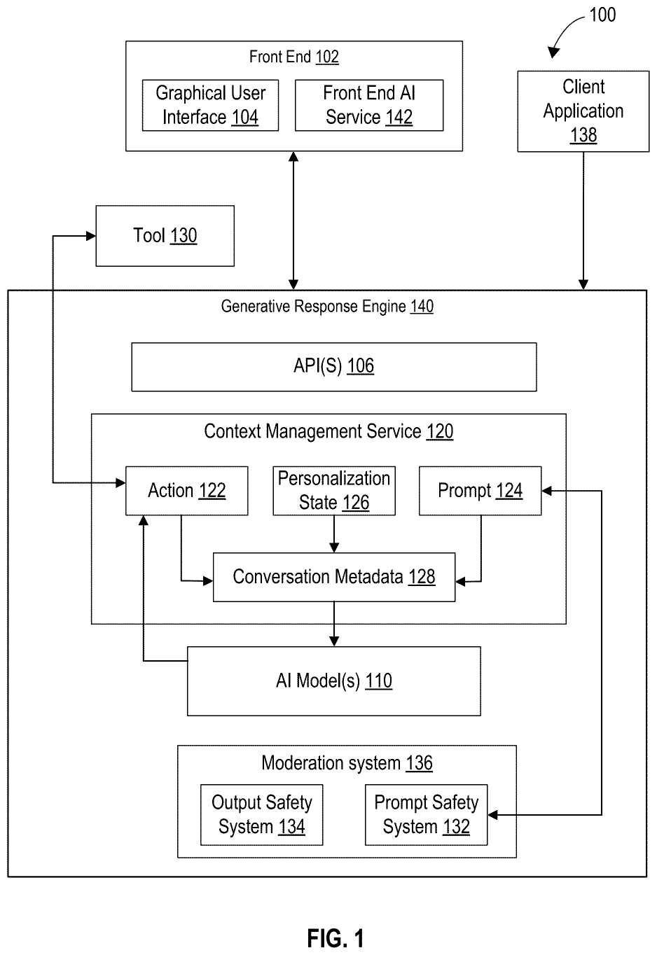

FIG. 1 illustrates an example AI assistant service 100 supporting a generative response engine during inference operations in accordance with some aspects of the present technology. Although the example system depicts particular system components and an arrangement of such components, this depiction is to facilitate a discussion of the present technology and should not be considered limiting unless specified in the appended claims. For example, some components that are illustrated as separate can be combined with other components, and some components can be divided into separate components.

AI model(s) 110 are artificial intelligence (AI) models that can generate content in response to a prompt. The prompt can be from a human or a software entity (AI or applications, such as client application 138). The prompt is generally in natural language but could be in code, including binary. Some examples of AI model(s) 110 can include language models that generate language, such as CHATGPT, or other models, such as DALL-E or IMAGEGEN, which generate images, and SORA, which generates videos. CHATGPT, DALL-E, IMAGEGEN, and SORA are all provided by OPENAI, but AI model(s) 110 are not limited to AI provided by OPENAI. AI model(s) 110 can also be any type of generative AI and can include AI developed using various architectures such as diffusion models and transformers (e.g., autoregressive transformer architecture) and combinations of models. Some AI models are multi-modal models that can receive and output data in text, image, audio, etc.

In some instances, a language model, such as CHATGPT, can receive prompts to output images, video, code, applications, etc., which it can provide by interfacing with one or more other models, as will be addressed further herein.

AI model(s) 110 may be part of a generative response engine 140, where generative response engine 140 may include one or more components for supporting interaction with AI model(s) 110. Users can interact with generative response engine 140 through a front end 102 and applications can interact with generative response engine 140 through APIs 106. Front end 102 serves as the interface and intermediary between the user and generative response engine 140. It encompasses a graphical user interface 104 which may be used to provide input that facilitate communication with generative response engine 140 and AI model(s) 110. Generally, users interact through a graphical user interface 104 that often includes a conversational interface, and applications interact through the API 106, but this is not a requirement.

While some components are shown as being part of generative response engine 140 and some are outside of generative response engine 140, this is for illustration purposes and some components such as tool 130 might be part of generative response engine 140, and some components such as moderation system 136 might be outside of generative response engine 140. As used herein, generative response engine 140 encompasses deterministic services that are first-party services that prepare prompts to be sent to AI models, that are primitive level services that AI model(s) 110 can utilize to generate a response to a prompt. Services that are outside of generative response engine 140 are logically separate. For example, front end 102 might be a first-party front end (provided by the same party that provides generative response engine 140) but front end 102 is used to interface with generative response engine 140 rather than aid in developing a response to a prompt.

Some components of generative response engine 140 might be executed by computing programming units (CPU), and some components might be executed by graphical processing units (e.g., AI model(s) 110).

In some embodiments, client application 138 might provide a graphical user interface that is custom to client application 138 or can display graphical user interface 104 provided by generative response engine 140 provider.

Graphical user interface 104 is the platform through which users interact with the generative response engine 140. It can be a web-based chat window, an application, or any interface that supports data input and output. Graphical user interface 104 facilitates a conversation between the user and AI model(s) 110, as the user provides prompts in graphical user interface 104 to which AI model(s) 110 respond, and generative response engine 140 presents those responses in graphical user interface 104. In some aspects, graphical user interface 104 presents a conversational interface, which has attributes of a conversation thread between a user account and AI model(s) 110.

Graphical user interface 104 is configured to perform input handling and output presentation. The type of inputs that can be received can be relative to the specifics of generative response engine 140 and/or AI model(s) 110. For example, a language model is generally configured to accept text, but when the AI model is a multi-modal AI model, front end 102 can accept voice and images/video.

In some aspects, front end 102 can be a layer to accept any inputs, provide the inputs to generative response engine 140, receive outputs from generative response engine 140 and display the outputs. Graphical user interface 104 can accept any input types as part of the prompt, and front end AI service 142 can determine which AI model or collection of AI models are best suited to respond to the prompt. Front end AI service 142 can be one or more AI models that can be trained to determine which AI model should be used to respond to a prompt, and in some examples, can be used to improve prompts or provide additional configuration details, such as how long a reasoning model should spend processing a prompt. In general, front end AI service 142 can support functions of graphical user interface 104 by performing interference operations before a prompt is sent to generative response engine 140. Generally graphical user interface 104 is present on a client device, while front end AI service 142 might be present on the same client device or on a server in a data center.

Graphical user interface 104 is also configured to maintain the context of the conversation, which allows for coherent and relevant responses. For example, graphical user interface 104 is responsible for providing the conversation thread and other relevant context accessible to the front end 102 to the AI models along with the specific prompt. In an example, a conversation between the user account and the AI model(s) 110 can have taken several turns (prompt, response, prompt, response, etc.). When the user account provides a further prompt, the graphical user interface 104 can provide that prompt to AI model(s) 110 in the context of the entire conversation.

In another example, graphical user interface 104 might be configured to provide a system prompt along with a user-provided prompt. A system prompt is hidden from the user account and is used to set the behavior and guidelines for the AI model. The system prompt can be used to define the AI's persona, style, and constraints. There can be levels of system prompts. A highest level of a system prompt might be provided by the AI model(s) 110 provider and is meant to establish policies for the behavior of AI model(s) 110. This highest level of system prompt should be prohibited from being edited. A customization system prompt can be used to customize the behavior of the AI model and is often provided through an API call, or provided by a user account when creating a customized version of AI model(s) 110. A still lower level of system prompt might include hidden information about a task. This can include chain-of-thought from a reasoning model, or context about an application that AI model(s) 110 is working with to complete a task. Accordingly, graphical user interface 104 does not display all of the output of the AI model.

Graphical user interface 104 is also configured to display the responses from the AI model, which might include text, code snippets, images, or interactive elements.

In some aspects, AI model(s) 110 can provide instructions to front end 102 that instruct graphical user interface 104 about how to display some of the output from the AI model. For example, the AI model and/or generative response engine can direct graphical user interface 104 to present code in a code-specific format, or to present interactive graphics, or static images. In other examples, the AI model and/or generative response engine can direct graphical user interface 104 to present an interactive document editor where graphical user interface 104 can be presented with the document editor so that the user account and the AI model can collaborate on the document.

In some aspects, AI model(s) 110 can provide instructions to personalization state 126 to record facts in a personalization notepad. Personalization state 126 can store information received directly from the user account or inferred from prompts provided by the user account, and can be used to provide context to the AI model such that output is personalized for the user account. In some examples, front end 102 can be configured to notify the user account that a memory was created. Personalization state 126 can also include summaries of past conversation threads between the user account and the generative response engine 140, and/or a searchable index of past conversation threads. In this way, personalization state 126 aid generative response engine 140 and/or AI model(s) 110 to learn specific facts about a user account and recall past interactions. The past interactions can be used to guide future responses by generative response engine 140 and/or AI model(s) 110 such that generative response engine 140 and/or AI model(s) 110 becomes personalized to a particular user account.

Generative response engine 140 can provide one or more APIs 106. APIs enable developers to integrate the AI model's capabilities into external applications and services. APIs 106 provide programmatic access to generative response engine 140, allowing for customized interactions and functionalities. While APIs 106 are shown as part of generative response engine 140, in some examples, APIs 106 are part of front end 102. API 106 can refer to points of access to AI model(s) 110. In some examples, API 106 endpoints are located at context management service 120.

APIs 106 can accept structured requests containing prompts, context, and configuration parameters. For example, an API can be used to provide prompts and divide the prompt into system prompts and user prompts. In some aspects, APIs 106 can provide specific inputs for which AI model(s) 110 are configured to respond with a specific behavior. For example, an API can be used to specify an output in a particular format or structured output. For example, in the chat completion API, the API call can specify parameters for the output, such as the max length for the desired output, and specify aspects of the tone of the language used in the response. The output can also be structured output and in a data interchange format such as JavaScript object notation (JSON). For example, the input query may include a schema that identifies a specific output structure. Some common APIs are for participating in a conversation (Chat Completion API), for providing a single response (Completion API), for converting text into embeddings (Embeddings API), etc. The API can also be used to indicate specific decision boundaries that AI model(s) 110 might be trained to interpret. For example, the moderation API can take advantage of AI assistant service 100's content moderation decision-making. In the case of the moderation API and others, the API might give access to services other than the AI model. For example, the moderation API might be an interface to moderation system 136, addressed below.

Some other common APIs include the Fine-Tuning API, which allows developers to customize AI model(s) 110 of generative response engine 140 using their own datasets; the Audio and Speech APIs, which cause AI model(s) 110 to output speech or audio; and the Image Generation API, which causes AI model(s) 110 to output images (which may request operations of other models).

There can also be APIs that direct AI model(s) 110 and/or generative response engine 140 to interface with other applications or other generative AI engines. In such cases, the specific application or AI engine might be specified, or AI model(s) 110 might be allowed to choose another application of generative response engine 140 to use in response to a prompt.

As described herein, a Responses API can be an improved API for interacting with AI model(s) 110. Responses API can take as a parameter a response ID, which can be used to return AI model(s) 110 to a state that the model was in at a particular response, thereby allowing a user account or developer to recall a previous context without having to re-prompt AI model(s) 110 or having to replicate a previous series of prompts. Further, Responses API can facilitate function/tool chaining to enable execution of operations requiring several function/tool calls without the added overhead of responding to an API caller to call the function or tool. Instead, deterministic code associated with the API can be directed to call functions or tools (including other AI models) on behalf of the AI model, and return data resulting from the function or tool call to the AI model.

In short, graphical user interface 104 and APIs 106 can be used to provide prompts to AI model(s) 110 of generative response engine 140. Prompts are sometimes differentiated into prompt types. For example, a system prompt can be a hidden prompt that sets the behavior and guidelines for the generative response engine. A user prompt is the explicit input provided by the user, which may include questions, commands, or information.

Generative response engine 140 may also include a context management service 120. The function of context management service 120 is to manage and organize the flow of data among key subsystems, enabling AI model(s) 110 to generate responses that are contextually relevant, accurate, and enriched with additional information as required.

Action 122 facilitates auxiliary tasks that extend beyond basic text generation. In some aspects, action 122 can be actions that correspond to an API 106. In some aspects, action 122 can be agentic actions that AI model(s) 110 decide to take to carry out a user's intent as described in the prompt. For example, an action can be to call tool 130 or even other AI model(s) 110. Tools 130 can include internet browsers, editors such as code editors, other AI tools, etc. While tools are shown outside of generative response engine 140, some tools might be part of generative response engine 140 and some tools might be external tools.

Prompt 124 is the request or command provided by the user account through front end 102. In some aspects, prompt 124 can be further supplemented by a system prompt and other information that might be included by graphical user interface 104 or API 106 or associated with a custom AI model. In some aspects, prompt 124 can be modified or enhanced by AI model(s) 110 as addressed further below. Additionally, as the user account provides prompts and AI model(s) 110 provide responses, a conversation thread forms. As the user account provides a new prompt, this is appended to the overall conversation and added to prompt 124. Thus, a user account might think of a first user-provided message as a first prompt and a second user-provided message as a second prompt, and so on, but prompt 124 as perceived by AI model(s) 110 can include a thread of user-provided messages and responses from AI model(s) 110 in a multi-turn conversation. The actors in the conversation thread can be labeled so that AI model(s) 110 can review the turns of the conversation. Generally, prompt 124 will include an entire conversation thread, but in some instances, prompt 124 may be shortened if it exceeds a maximum accepted length (generally measured by a number of tokens).

In some examples, context management service 120 can also route prompts and response through moderation system 136. In some aspects, prompts are provided to prompt safety system 132 before being provided to AI model(s) 110. Prompt safety system 132 is configured to use one or more techniques to evaluate prompts to ensure a prompt is not requesting AI model(s) 110 to generate moderated content. In some aspects, prompt safety system 132 can utilize text pattern matching, classifiers, and/or other AI techniques.

Since prompts can evolve over time through the course of a conversation, consisting of prompts and responses, prompts can be repeatedly evaluated at each turn in the conversation.

Personalization state 126 can facilitate continuity and personalization in conversations. It allows the system to maintain user-specific context, preferences, or details that may inform future interactions. Personalization state 126 can include a memory file of persisted data from previous interactions or sessions that provide background information to maintain continuity. In some aspects, information can be recorded to personalization state 126 at the instruction of AI model(s) 110 when AI model(s) 110 identify a fact or data that it determines should be saved in memory because the fact and/or data might be useful in later conversations or sessions. In some aspects, personalization state 126 can also include synthesized concepts extracted from past conversation threads, and personalization state 126 can also encompass the ability of AI model(s) 110 to search through past interactions to find relevant information to a current conversation thread.

Conversation metadata 128 can aggregate data points relevant to the conversation, including user prompt 124, action 122, and personalization state 126. This consolidated information package serves as the input for AI model(s) 110. Conversation metadata 128 can label parts of a prompt as user-provided, AI model-provided, a system prompt, personalization state 126, data from action 122 or tool 130 (addressed below).

AI model(s) 110 are the core engines that process inputs (from context management service 120) and generate outputs. In some aspects, AI model(s) 110 may be a generative transformer, or autoregressive transformer, but could use other architectures. In some examples, the transformer is multi-modal transformer that can use audio tokens (or embeddings thereof), visual tokens (or embeddings thereof), and language (or embeddings thereof) as needed.

A core feature of AI model(s) 110 is to generate content in response to prompts. The prompt can be from client application 138 provided via graphical user interface 104. AI model(s) 110 can be configured to receive inputs via APIs 106 that provide guidance on a desired output. AI model(s) 110 can analyze the input and identify relevant patterns and associations in the data, and generate a sequence of tokens that are predicted as the most likely continuation of the input. AI model(s) 110 generate responses by sampling from the probability distribution of possible tokens, guided by the patterns observed during its training. Two features of the autoregressive transformer that result in this functionality are that the autoregressive transformer might use the decoder part of the transformer architecture and that it utilizes self-attention. By using the decoder part of the transformer architecture, the transformer focuses on predicting the tokens given the previous context tokens. The self-attention mechanism captures long-range dependencies amongst tokens, allowing it to generate contextually relevant responses (in text, audio, images, and video).

In some aspects, AI model(s) 110 can generate multiple possible responses before presenting the final one. AI model(s) 110 can generate multiple responses based on the input, and these responses are variations that AI model(s) 110 consider potentially relevant and coherent.

In some aspects, AI model(s) 110 can evaluate generated responses based on certain criteria. These criteria can include relevance to the prompt, coherence, fluency, and sometimes adherence to specific guidelines or rules, depending on the application. Based on this evaluation, AI model(s) 110 can select the most appropriate response. This selection is typically the one that scores highest on the set criteria, balancing factors like relevance, informativeness, coherence, and content moderation instructions/training.

In some aspects, an instruction provided by an API 106, a system prompt, or a decision made by AI model(s) 110 can cause AI model(s) 110 to interpret a prompt and re-write it or improve the prompt for a desired purpose. For example, AI model(s) 110 can determine to take a prompt to make a picture and enhance the prompt to yield a better picture. In these instances, AI model(s) 110 can generate their own prompts, which can be provided to tool 130 or provided to AI model(s) 110 to yield a better output response than the original prompt might have.

AI model(s) 110 can also do more than generate content in response to a prompt. In some aspects, AI model(s) 110 can use decision boundaries to determine the appropriate course of action based on the prompt. In some examples, a decision boundary might be used to cause the AI model to recognize that it is being asked to provide a response in a particular format such that the AI model will generate its response constrained by the particular format. In some examples, a decision boundary can cause the model to refuse to generate a responsive output if the decision is that the responsive output would violate a moderation policy. In some examples, the decision boundary might cause the AI model to recognize that it interfaces with another AI model or application to respond to the prompt. For example, when the AI model is a language model, it might recognize that it is being asked to output an image, and therefore, it interfaces with a model that can output images to provide a response to the prompt. In another example, the prompt might request a search of the Internet before responding. The AI model can use a decision boundary to recognize that it should conduct a search of the Internet and use the results of that search in responding to the prompt. In another example, the prompt might request that the AI model take an agentic action on behalf of the user by interacting with a third-party service (e.g., book a reservation for me at . . . ), and the AI model can use a decision boundary to recognize that it should plan steps to locate the third-party service, contact the third-party service, and interact with the third-party service to complete the task and then report back to the user that the action has been completed.

When AI model(s) 110 determine to take an agentic action on behalf of the user or to call a tool to aid in providing a quality response to the user account, AI model(s) 110 might call a tool 130 or cause an action 122 to be performed. As indicated above, tools 130 can include internet browsers, editors such as code editors, other AI tools etc. Actions 122 are actions that AI model(s) 110 can cause to be performed, perhaps using tool 130. As used herein actions 122 should be considered to cover a broad array of actions that AI model(s) 110 can perform with or without tools 130. Tools 130 are considered to cover a wide variety of services and software that encompass tools such as a computer operating system such that AI model(s) 110 can control the computer operating system on the user's behalf, to robotic actuators, to search browsers and specific applications.

Additionally, AI model(s) 110 can also generate portions of responses that are not displayed to the user. For example, AI model(s) 110 can direct front end 102 to provide specific behaviors, such as directions for how to present the response from AI model(s) 110 to the user account. In another example, AI model(s) 110 can provide response portions dictated by APIs 106, where portions of the response to the API might be for the consumption of the calling application but not for presentation to the end user. In another example, some AI model(s) 110 are reasoning models, which are AI model(s) 110 that are configured to output a raw chain-of-thought before preparing a final response to a prompt. The raw chain-of-thought might not be presented to a user account or application calling an API. Instead, another AI model might summarize the raw chain-of-thought into a more consumable and useful output for the user account or application.

In some aspects, the output of the AI model can be further analyzed by output safety system 134. While AI model(s) 110 can perform some of their own moderation, there can be instances where it is beneficial to have another service review outputs for compliance with a moderation policy. The use of dashed lines in FIG. 1 differentiates a path using output safety system 134 and not using output safety system 134.

As used herein, the present description may refer to the generative response engine or AI model(s) making a determination or reasoning prior to providing a response to a prompt. Determining can refer to a process by which an AI model outputs a response that provides a conclusion. In an example, an AI model can perform an inference operation to output a sequence of tokens, which output provides a determination. In such an example, the AI model might not have made any decision other than to sample particular tokens to provide an output, yet the response from the AI model might be a statement of determination. In another example, AI models can be trained to make particular determinations. In such examples, the AI model can be trained to make a decision, such as to cross a decision boundary to take an agentic action or to call a tool, etc.

Reasoning refers to simulating logical processes to draw conclusions or perform tasks based on provided inputs and learned information. Although the AI model might lack true understanding, the AI model uses pattern recognition and linguistic associations to emulate reasoning by linking related concepts and predicting outcomes. As used herein, the term reasoning by an AI model refers to the process performed by AI models known as reasoning models.

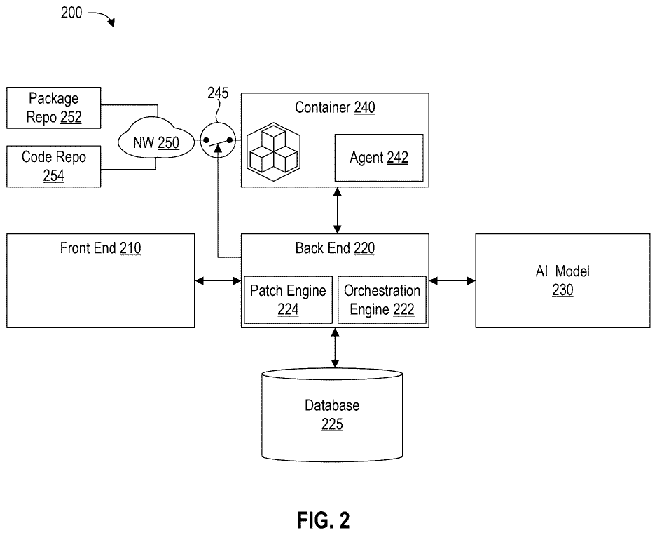

FIG. 2 is a conceptual block diagram of an automated software development system 200 using a generative response engine in accordance with some aspects of the disclosure. In some aspects, automated software development system 200 includes components of a generative response engine, such as a front end 210 (e.g., front end 102), back end 220, and AI model 230 (e.g., a transformer-based model, etc.).

In some aspects, AI model 230 is a foundation model, which is large-scale, pre-trained model built on vast and diverse datasets, designed to generalize across a wide range of downstream tasks such as language understanding, code generation, image analysis, and more. Foundation models leverage transfer learning to adapt efficiently to new problems with minimal additional training. An example of a foundation model is a reasoning foundation model that uses chain-of-thought reasoning in which the model generates intermediate logical steps to arrive at a final answer. This process mimics human problem-solving by structuring the reasoning path, which improves both the accuracy and interpretability of the model's outputs. In some cases, the foundation model can be fine-tuned for specific tasks, such as software development, and the model can be pruned to reduce weights and its ability to perform general-purpose reasoning, thereby using fewer computational resources and improving efficiency for targeted applications.

In some aspects, front end 210 can be a client application that is presented at an edge device and can be configured in various forms, such as a native application, a cross-platform application using a webview renderer (e.g., Electron, etc.), or a web browser instrumented application with instructions (e.g., a JavaScript bundle such as React or WebAssembly bytecode, etc.). In some cases, client application can be retrieved from cloud computing service (e.g., as a JavaScript bundle) or may be rendered via cloud computing service via different techniques (e.g., server-side rendering, partial hydration, etc.).

The back end 220 provides an interface for front end 210 to interact with various components on a server or cloud. For example, back end 220 includes various services such as database 225, inspection services to analyze the safety of prompts, and interface with AI model 230. Back end 220 includes orchestration engine 222 and patch engine 224 to implement software development services. Orchestration engine 222 is configured to receive instructions from front end 210 and spawn a container 240 including a development environment. In some aspects, edge device (e.g., controlled by a user) can configure various aspects, such as an execution environment. The execution environment includes a base system (e.g., a Linux distribution) and can include instructions to build the base environment (e.g., a Docker file). The execution environment can also include additional instructions to instrument the development environment with various services, packages, package managers, servers, configurations, SDKs, and so forth. For example, the execution environment can include instructions to include a package manager (e.g., pip for Python, cargo for Rust, and npm for JavaScript, etc.) as well as various dependencies. As an example, a dependency can be a development tool (e.g., a linter for checking for errors before building, a prettier to consistently format code, etc.), a library for interacting with a database, a framework (e.g., React, etc.), a development package, and so forth.

Orchestration engine 222 receives various information from front end 210 including the execution environment, and spawns container 240 including the development environment (not shown) and service 242.

In some cases, the back end 220 may include a terminal service (not shown) that is configured to connect to a terminal interface (e.g., a pseudo-teletypewriter (PTY)) of the container 240 to allow interactive input and output. For example, processes in applications have standard byte streams for reading input (e.g., STDIN, STD_INPUT_HANDLE, etc.), writing output (e.g., STDOUT, STD_OUTPUT_HANDLE, etc.), and error or diagnostic messages (e.g., STDERR, STD_ERROR_HANDLE, etc.) that are readable and writable streams similar to any other byte-oriented I/O source or sink. The container 240 may provide a pseudo-teletypewriter (PTY) and connect to a shell of a container to enable interactive command execution inside the container, identification of errors, and control by the AI model for various software functions. In some cases, the terminal service may use a container service command (e.g., a docker command) to access the container (e.g., when the container is in a network isolated state).

The terminal service is configured to render output based on the bytestream using asynchronous techniques. For example, because the AI model and the commands executed within a shell of the container 240 operate at independent times (e.g., independent clocks), the interaction with the terminal service and the shell of the container 240 uses asynchronous hand−offs. For example, the terminal service continuously snapshots and renders the shell's buffer at discrete intervals, emitting a stream of frame updates (with cursor position, text cells, and CSI codes) to the AI model, which asynchronously decides on the next instruction. For example, the AI model can correct a syntax error or run a failed test. Decoupling command execution, terminal rendering, and model inference into separate event loops (for example, with promises or callbacks) ensures that the shell remains responsive, and commands executing in the shell do not block AI model, and the AI model operates from the latest rendered state. Although the terminal service is part of the back end 220, the terminal service can be part of the container 240 based on a suitable configuration.

In some aspects, container 240 has a lifecycle that is suitable for network applications. In particular, an instance of a container 240 is created, started, optionally paused, stopped, and eventually removed. At creation (e.g., docker create or docker run), container 240 is built from a specified image and includes an isolated environment, which contains the filesystem, environment variables, entrypoint, and network settings. When started, container 240 runs a defined process (e.g., in the dockerfile) with limited access to the host system. Container 240 is a sealed environment and can be accessed through services installed within the dockerfile. For example, access to container 240 (e.g., files, APIs, or other functionality) is provided via services installed and configured at build time (e.g., in the Docker configuration or the dockerfile). After container 240 is executed, container 240 can be accessed via the defined services, and there is implicit access to its contents. Once the process ends, container 240 stops. Any changes made within container 240 (e.g., to the filesystem) are generally ephemeral and are lost when the container is stopped or removed.

In some aspects, container 240 may include service 242 that is configured to interact with AI model 230. For example, AI model 230 may be executing in specialized hardware for floating point operations (e.g., a graphical processing unit (GPU), a multiply accumulate (MAC) unit, etc.). The container 240 can expose a port to allow service 242 to interact with AI model 230 and perform functions associated with AI model 230. In some cases, various actions by AI model 230 can compromise the actions performed within container 240, such as attempting a denial of service attack, posting malicious social media content, and so forth. Even though container 240 is an isolated environment, it can be sealed from external access, and internal commands may be permitted. For example, container 240 may execute shell commands (e.g., curl, etc.) or other applications (e.g., ping, etc.) that can be accessed for various malicious purposes.

In some aspects, switch 245 is configured to permit or deny access to external network 250 by container 240. Switch 245 may be a logical network interface of container 240, and switch 245 is illustrated to show that back end 220 controls whether container 240 can access external network 250 (not the internal network). In some aspects, switch 245 can be enabled for an initialization period associated with configuring the container. In this case, container 240 can use network 250 to access package repository 252 during an initialization period associated with container 240. Package repository 252 can include various software packages, container images, and other components to generate and configure container 240. In some aspects, orchestration engine 222 is also configured to cause container 240 to access code repository 254 to locally clone a public or private repository. For example, orchestration engine 222 can access GITHUB (either using a public interface or a private repository based on a stored secret of the user) and retrieve and store code repository 254 within container 240.

Switch 245 may disable access to network 250 after all code and packages are installed in container 240 and the initialization period ends. For example, switch 245 is enabled before AI model 230 is provided access to service 242 of container 240 and is disabled when AI model 230 has access to service 242 of container 240. In this case, container 240 is unable to access external network 250 and the data, packages, code, and other content installed on container 240 can be accessed via an internal interface (e.g., a network file system service). In this way, container 240 cannot perform any malicious actions outside of its environment and any harmful activities are restricted to its environment. In some aspects, switch 245 can be configured using an internal interface (e.g., iptables in a Linux container) or an external interface (e.g., via a control plane associated with a container service).

In some aspects, switch 245 can be configured based on user control. For example, a user, as part of a project or an execution environment, may elect to enable limited or unlimited network access. For example, the user may configure container 240 to control the scope of network access via a configuration to restrict access to particular domains and protocols. For example, a user repository may be focused on implementing a new service based on an API (e.g., weather.acme.com), and internal and external network access can be limited to network traffic to and from that fully qualified domain name. In other examples, network access can be time-limited based on an external request to an external service, requiring a response within a duration (e.g., 5 seconds). In some cases, container 240 could include default configurations that identify advertent or inadvertent misbehavior, such as a loop that continues to execute an identical network request based on an improper configuration. Table 1 below illustrates an example of rules that can be applied to a firewall of container 240, such as a command-line utility iptables, which configures the packet filtering rules of the Linux kernel firewall.

TABLE 1
# Default policy: drop everything
iptables −P INPUT DROP
iptables −P OUTPUT DROP
iptables −P FORWARD DROP
# Allow loopback for local apps
iptables −A INPUT −i lo −j ACCEPT
iptables −A OUTPUT −o lo −j ACCEPT
# Allow incoming established connections (like replies)
iptables −A INPUT −m state −−state ESTABLISHED, RELATED −j
ACCEPT
# Allow outgoing DNS (UDP port 53) to your resolver
iptables −A OUTPUT −p udp −−dport 53 −j ACCEPT
# Resolve acme.com to IP(s)
# (Always resolve outside iptables, e.g., use ‘dig‘ or ‘nslookup‘)
ACME_IP=$(dig +short acme.com | head −n 1)
# Allow outgoing traffic to acme.com IP on any port
iptables −A OUTPUT −d $ACME_IP −j ACCEPT

The use of iptables is an example for illustrative purposes. In some cases, the external network interface may be completely disabled, and the container can be accessed via an internal interface (e.g., docker exec) associated with the container service.

In some cases, as an alternative to disabling the external network access, the container may use a proxy to access an external network. In some cases, the back end (e.g., orchestration engine 222) can control the proxy dynamically and selectively control external network access based on software development task state. For example, a software development task may be associated with a specific API, and back end may configure the proxy to allow the container to connect to a domain associated with the API to develop network requests (e.g., HTTP verb commands such as get, post, etc.). In other cases, a proxy may allow interaction with other package repositories, API surfaces, and so forth. The proxy can also completely block network connections.

AI model 230 is configured to interact with service 242 of container 240 to generate code changes and other modifications within container 240 based on a natural language instruction. For example, service 242 can provide terminal access to AI model 230 (e.g., STDIN, STDOUT, STDERR) and allow AI model 230 to use the command line interface (CLI) to interact, read, and modify the copy of local code repository (e.g., cloned from code repository 254), run tests, and other developer functions. The service 242 can also include an interface that exposes an API to make modifications via commands that AI model 230 is trained with to provide discrete functions associated with a software development task. For example, AI model 230 can access a local GITHUB repository (e.g., the locally cloned repository within container 240) to create, read, update, and delete code files using an API. The AI model 230 behaves like an autonomous developer and reads code context, reasons about functionality or bugs, and produces inline edits, new code, and removes code as needed. The AI model 230 is able to perceive the entire context of the project while isolating changes to container 240.

Conventional automated development techniques either use direct access to a live system to directly modify files without network isolation (e.g., within a local development environment) and risk potential malicious behavior, or an incomplete understanding of the environment based on modification of a part of a repository within a web-based environment. For example, the local configuration can include various settings (e.g., a linter, a configuration file, etc.) and copying the code from a web-based front end may require additional modification to match the local development environment. For example, if the noImplicitAny flag is set to false in a local TypeScript configuration file and the code has implicit any return values, copying the changes from a web-based environment can create additional errors within the copied instructions based on differences in the local development environment and the web-based front end.

In some aspects, AI model 230 is configured to execute in a different hardware environment and can access service 242 to interact with the software development environment. For example, AI model 230 is typically executed at inference (e.g., at runtime) on specialized hardware, such as GPUs or custom accelerators, such as tensor processing units (TPUs), that are configured for large-scale matrix math. ML inference and training involve massive parallel floating-point computations (e.g., matrix multiplications) that are faster on GPU hardware. For example, AI model 230 may require access to high-throughput memory (e.g., high bandwidth memory (HBM)) and parallel processing cores that are not available in conventional CPU architectures.

Multiple instances of automated software development system 200 may execute in parallel to handle different tasks. For example, a first instance of automated software development system 200 can add database integration, a second instance of automated software development system 200 can add authentication, and a third instance can add a new feature.

After the task by AI model 230 is completed, orchestration engine 222 is configured to use service 242 to extract the development data associated with the task, which includes modifications, commands, changes, and any events that occurred within container 240 while being controlled by AI model 230. Orchestration engine 222 stores the development data in database 225.

Patch engine 224 is configured to access the development data extracted by orchestration engine 222 and generate a change proposal associated with code repository 254. For example, patch engine 224 can run commands to deterministically produce a diff of all the changes made within the development data. In some cases, patch engine 224 may be configured to receive the development data and identify the various changes (e.g., using a deterministic diff) and store the modifications in database 225.

In some aspects, AI model 230 can generate and output the diff to database 225. For example, AI model 230 can call a deterministic function. In some cases, AI model 230 may be able to reason and generate the diff during inference. In some cases, AI model 230 can also review the changes to validate that its reasoning corresponds to the generated instructions.

Patch engine 224 (or AI model 230) generates a diff that identifies a representation of changes (e.g., insertions, deletions) in a particular file. AI model 230 can be configured to output structured information using various techniques, such as a data validation function or library (e.g., zod) that validates data types that cross system boundaries. Table 2 below illustrates a diff command of two files (e.g., ./a/hello.txt and ./b/hello.txt) and a corresponding output format that identifies line-based changes (e.g., @@−1+1,2 @@ indicates to remove a line, and add two, followed by the lines to remove based on a leading “−” lines to add based on a leading “+”).

TABLE 2

diff −−git a/hello.txt b/hello.txt
index e69de29..a3c1234 100644
−−− a/hello.txt
+++ b/hello.txt
@@ −1 +1,2 @@
−Hello world
+Hello world!
+Goodbye world.

In some aspects, automated software development system 200 is configured to generate a change proposal associated with code repository 254. For security purposes, automated software development system 200 may not be configured to directly access code repository 254 and can generate the change proposal for the user's review. The change proposal also includes additional information that can be used to generate all changes based on a state of code repository 254. For example, the change proposal can include a source branch containing proposed changes, a target branch where the changes are intended to be merged, a commit history that outlines the modifications, a diff showing line-by-line changes to files, and optional metadata such as a title, description, reviewers, and discussion comments for code review and collaboration. For example, a commit is a snapshot of a repository at a specific point and links to a tree of that snapshot. The commit includes a pointer to a tree object (e.g., a tree of files), a list of parent commits (for history), and other metadata (e.g., author, timestamp, commit message, etc.). The commit points to the new tree and the previous commit and allows a graph to be constructed to identify changes to be made out of order.

In some aspects, the change proposal, or at least parts of the change proposal and generated and provided to back end 220 based on user input. For example, front end 210 can display various options associated with the change proposal, such as the ability to view and generate a pull request. Based on the user input, back end 220 accesses database 225 and generates the change proposal.

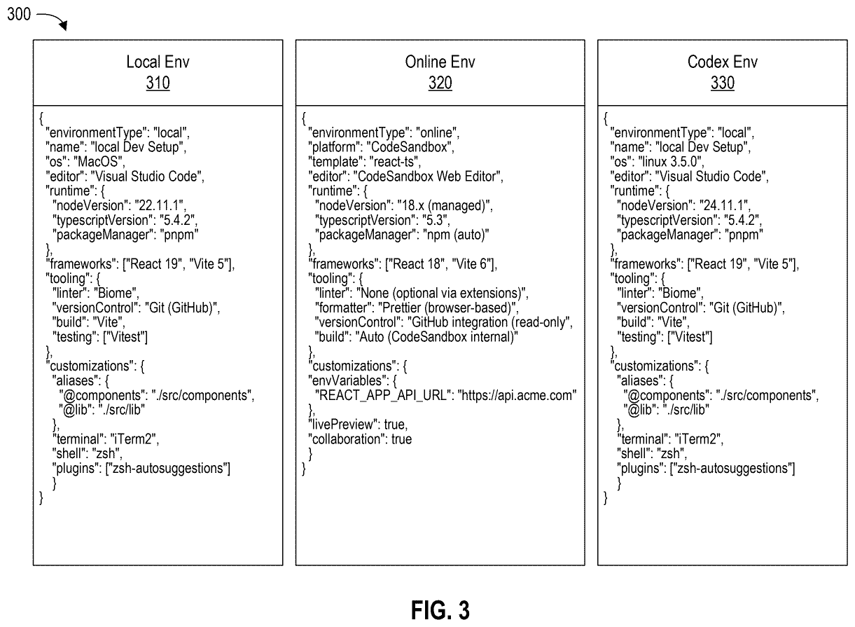

FIG. 3 is an illustration 300 of different development environments in accordance with some aspects of the disclosure. In particular, FIG. 3 illustrates a local development environment 310 (e.g., on a local computer), an online development environment 320 (which can include simulated environments such as a chat interface), and a container environment 330. In some aspects, a user's local development environment 310 includes a variety of tools and libraries that are installed and configured within the local development environment 310 to develop code. The local development environment 310 is configured to connect to a service for version control, collaboration, and continuous integration workflows (e.g., a git server, GITHUB, GITLAB, BITBUCKET, etc).

The local development environment 310 can include various configurations that are relevant to the repository that affect how the development environment operates. For example, the local development environment 310 illustrates the configuration of the development environment in JavaScript Object Notation (JSON) to illustrate different features relevant to the environment. For example, the local development environment 310 can include aliases that allow import statements to refer to features (e.g., import {Custom} from “@/components/Custom.tsx” as opposed to import {Custom from “../../../components/Custom.tsx”, etc.). The local development environment 310 can include various features such as a server (e.g., a node server version 22.11.1), package managers, linters, testing, version control, building, testing, a prettier (e.g., for automatically formatting code for consistency).

An online development environment 320 closely follows the general outline of the framework, such as the framework, installed packages, and so forth. However, the online development environment 320 may not necessarily have the same tooling configuration, such as a different linter, or a different TypeScript configuration, etc. For example, the local development environment 310 uses biome, which integrates both linting and prettier tooling, whereas the online development environment 320 may use a fixed linter (e.g., for type checking) and a separate prettier.

The configuration of the local development environment 310 and the online development environment 320 can include many differences that affect various features, such as linting, type checking, appearance, etc. For example, the local development environment 310 may include specific configurations for biome (e.g., biome.json) that define defaults, errors, warnings, and so forth. When developing code within the online development environment 320, the specific features defined in the local development environment 310 cannot be accurately recreated based on package differences, runtime differences, type definitions, etc. For example, within a typescript configuration file (tsconfig.json), different options, such as disabling implicit settings, configuring the module resolution technique, can affect how code performs. In addition, differences in the operating systems between the local development environment 310 and the online development environment 320 can lead to variations in file system naming rules, such as case-sensitive versus case-insensitive behavior. (e.g., case-sensitive versus case-insensitive). Table 3 below illustrates an example function that works in the online development environment 320.

TABLE 3

```
function sumPositiveNumbers(numbers) {
  return numbers.reduce((sum, val) => {
    if (val > 0) {
      sum += val;
    }
    return sum;
  });
}
```

In the example in Table 3, there are no type errors and the example runs correctly in the browser. Its behavior is also correct and returns the sum of positive numbers when tested with [1, −2, 3], etc. In the event the code is copied into the local development environment 310 (which includes a strict TypeScript or Node.js project with strictNullChecks or noImplicitAny), the function has two key problems. First, the function is missing an initial value in the reduce( ) function. In a browser environment, the JavaScript coerces sum to undefined in the first call, which may work if the first element is positive. However, in a Node environment or when the array is empty or the first element is negative, this function causes sum+=val to fail (e.g., undefined+val). In this case, the error causes a type error in TypeScript (e.g., Parameter “sum” implicitly has an “any” type). This function is also missing type annotations, and TypeScript will not infer the return type (e.g., number|number[]) under a strict configuration. For example, in the local development environment 310, sumPositiveNumbers([]) throws a type error and sumPositiveNumbers([−1, −5]) returns undefined or crashes, depending on the engine. In addition, the function may cause a crash when an empty array is provided because a numeric value will not be returned. Table 4 below illustrates the correct code that prevents these issues.

```
TABLE 4
function sumPositiveNumbers(numbers: number[ ]): number {
  return numbers.reduce((sum: number, val: number): number => {
    if (val > 0) {
      return sum + val;
    }
    return sum;
  }, 0);
}
```

In Table 4, the function is made safe and predictable by explicitly declaring that it accepts an array of numbers (number[]) and always returns a number. The type annotation prevents accidental passing of non-numeric values at compile time. In addition, the reduce method is given a safe initial value of 0, eliminating the problem of starting the sum with the first array element, which could be negative or undefined, and ensures that empty arrays return 0 instead of throwing a TypeError. Inside the reducer, both parameters and the return type are explicitly typed and guarantee that the accumulation process always operates on and produces numeric values. The illustrated changes remove the edge cases that could cause incorrect sums or runtime errors, while making the intended behavior clear and enforceable.

There are many other potential issues that can create friction between the automated software development process and the integration into production pipelines. For example, code that executes without errors in the online environment may fail when imported into the local IDE due to differences in file naming, module resolution, or filesystem behavior, creating friction in the workflow when merging code from the browser to the desktop.

Testing and integration workflows are also affected by these differences. In an online development environment, execution is often limited to the capabilities of the in-browser runtime, which may not fully replicate the behavior of the target production environment. Developers may lack access to certain system-level APIs, hardware integrations, or network configurations, leading to incomplete or misleading test results. When the code is migrated to a local IDE for integration into a larger project, these environmental constraints disappear, revealing bugs or incompatibilities that were masked during online testing. This mismatch between the online sandbox and the local development setup creates additional debugging cycles, slows down integration, and increases the risk of defects slipping into production.

In addition, merging code from an online development environment into a local IDE workflow can also introduce version control and repository integration challenges. Online environments may not fully mirror the Git configuration, branching strategies, or commit history maintained in the local repository. When developers export code from the browser-based workspace and attempt to merge it into the local codebase, differences in file structure, line endings, indentation styles, and ignored files can create unexpected merge conflicts. In some cases, auto-generated configuration files or environment-specific dependencies from the online platform can be inadvertently committed, introducing instability into the local project. These repository-level inconsistencies add further overhead, requiring manual reconciliation before the merged code can be built, tested, and deployed within the standard local development pipeline.

In some aspects, container environment 330 can be configured to mimic the local development environment 310 and allow the developed code that correspond to the code repository. For example, container environment 330 includes using a package file of a code repository (e.g., access code repository 254) to generate the container environment 330 but with minor differences to account for container differences. For example, containers are most commonly Linux because cost and customization ability is unmatched by any commercial operating system. The container environment 330 can also be configured to have different versions of the server based on slight variations across the local development environment 310 and the container environment 330, as well as TypeScript implementations and local development servers. Despite these minor variations, the container environment 330 can configure the AI model to develop code that substantially matches code developed in the local development environment 310. For example, the container environment 330 can use a similar version, which may be different for a variety of reasons, such as the execution environment specified by the automated software development system (e.g., automated software development system 200).

In some aspects, the automated software development system may also be aware of the differences associated with the local development environment 310 and the container environment 330 can consider these modifications. For example, the local development environment 310 may be case-insensitive, and the container environment 330 may be case sensitive, which can lead to issues in development, deployment, and code repository management. Code that executes without errors in the online environment may fail when imported into the local IDE due to differences in file naming, module resolution, or filesystem behavior, creating friction in the workflow when merging code from the browser to the desktop.

In addition to filesystem sensitivity, discrepancies can arise from differences in toolchains, language runtimes, and build configurations between the online development environment and the local IDE. Browser-based environments often provide preconfigured, sandboxed versions of compilers, interpreters, and libraries, while local IDEs may rely on system-installed tools or project-specific configurations. This divergence can result in situations where code that passes all tests online encounters missing dependencies, version mismatches, or incompatible API calls when run locally. These inconsistencies make it harder to maintain a single, synchronized codebase and require developers to spend additional time reconfiguring their local environment or rewriting code to match the conditions of the online platform.

In some aspects, the containerized software development process is designed to mimic the local development environment as closely as possible, ensuring a smooth transition between the developer's setup and the container runtime. As shown in FIG. 3, the containerized environment may align with the local environment's operating system, runtime versions, frameworks, and tooling configurations. The user can also customize the execution environment, for example by specifying the Node.js version, TypeScript compiler version, or package manager used within the container. These customizations allow the container to replicate the functional behavior of the local IDE in addition to the nuanced developer preferences, thereby reducing discrepancies and avoiding environment-induced bugs.

The containerized process may also incorporate the same code repository features found in the local setup, such as linter configurations, formatter settings, and version control integrations. This synchronization allows code style and formatting rules to remain consistent across local, containerized, and eventual production environments. By standardizing these rules, the containerized workflow ensures that code contributions from multiple developers maintain a uniform appearance and adhere to the same quality checks, reducing merge conflicts and stylistic inconsistencies.

In some aspects, as part of generating the container, the automated software development system may be configured to read an AGENTS.MD file, which contains additional instructions and guidelines that go beyond automated linting rules. For example, an AGENTS.MD file may specify whether to use tabs or spaces, preferred naming conventions, commit message styles, or architectural guidance for structuring components. Linter configurations enforce many syntax and style requirements and the AGENTS.MD file to supplement the linting by conveying more subjective or process-oriented guidelines that are important to the team but cannot be easily codified in tooling (e.g., naming conventions, etc.). The AGENTS.MD file can also provide explicit coding styles, limitations, and explanations for the automated software development system to understand (e.g., a deployment limitation). The additional contextualized information enhances the operation of the AI model by providing a flexible mechanism for communicating development standards and other supplementary information directly into the execution environment.

Multiple container instances can be spawned in parallel to execute variations of the same development task, implementing a best-of-N selection process. For example, the system may generate different versions of a component using alternative libraries, architectural patterns, or dependency sets. Each version can then be built, tested, and evaluated in isolation, allowing the user to select the implementation that best meets the desired performance, maintainability, or compatibility criteria. For example, the multiple container instance can identify edge cases and uncover compatibility issues with specific library versions that may cause downstream adverse effects, changes to an existing architecture, or explore design trade-offs before committing to a single solution. In many cases, a project can be significantly advanced in implementing a feature to realize that a downstream aspect is affected in a negative way. A best-of-N approach can help surface deep issues that can arise later in a development cycle.

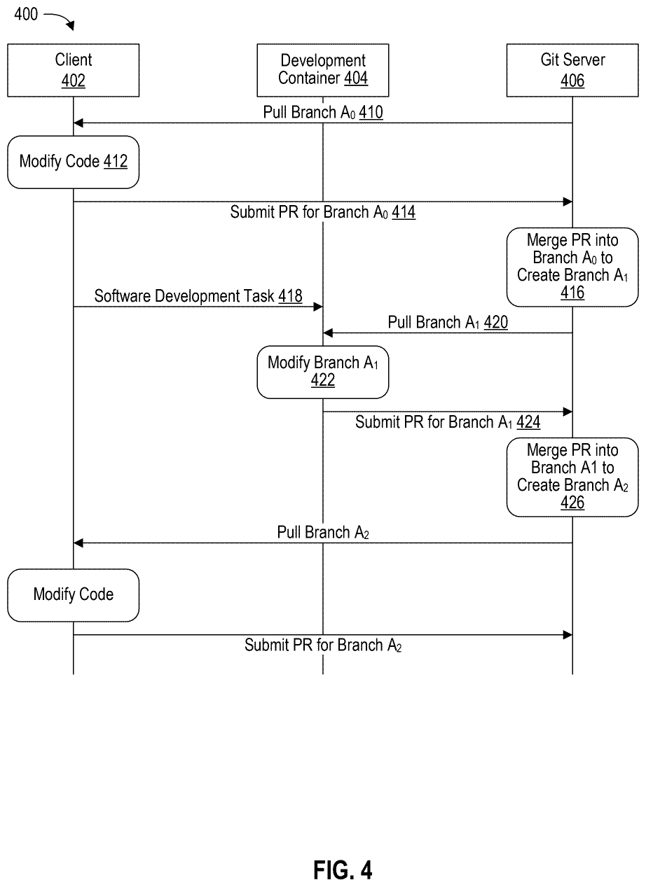

FIG. 4 is a sequence diagram 400 illustrating an automated software development process that integrates with a conventional software development process in accordance with some aspects of the disclosure. In some aspects, the sequence diagram 400 illustrates a software development workflow in which a client device 402, a development container 404, and a source code repository or Git server 406 interact to iteratively create, modify, and merge software code. In particular, the sequence diagram 400 illustrates how automated software development process can work can seamlessly work with a conventional developer process by spawning a development container 404 (e.g., associated with automated software development system). In some examples, the development container 404 may be accessible by a generative response engine.

The development container 404 is a containerized environment configured to closely replicate the target execution environment, and incorporates an AI-powered model that can directly access and modify the code inside the container. The automated software development process is designed so that the workflow steps align with natural human development patterns, allowing a developer to perform a change manually and then seamlessly hand off the next change to the automated software development process, or vice versa. This interchangeability ensures that human-driven and automated contributions follow the same repository and branching conventions, making collaboration between humans and the AI model both fluid and natural.

As an example, the client device 402 (e.g., via a developer) may initially perform a manual development iteration. For example, the client device 402 pulls (e.g., git pull) an initial branch A₀ from the Git server 406 at reference numeral 410. This operation synchronizes a code repository at the client device 402 and a corresponding branch A with the Git server 406. In this case, the client device 402 may select a branch for development (e.g., experimental) of the code repository, which causes the client device 402 to an initial branch A₀ to be retrieve from the Git server 406 and update corresponding files on the client device 402. As part of this process, the client system device can be synchronized with the Git server 406 and include various standards to align the local development of the code repository. In some cases, the initial branch A₀ can include features such as configuration files (e.g., typescript configuration file tsconfig.json, etc.), static data, tests, etc. In general, client-specific secrets are excluded from the code repository to prevent leakage.

At block 412, the developer performs a manual modification to the code in branch A₀ at block 412. Non-limiting examples of manual modification include writing new functionality, fixing bugs, restructuring existing code, configuring various settings, configuring tests, and so forth.

At reference numeral 414, the client device 402 submits a pull request (PR) to the git server 406 to merge branch A₀ into the code repository. For example, a PR is a request to merge changes from a feature or working branch into another branch within a version-controlled repository. When a PR is created, Git server 406 receives the branch's commit history, the specific code modifications (e.g., diffs) relative to the target branch, and associated metadata such as author information, timestamps, commit messages, and any linked issue or task references. This information allows the collaborators to review, test, and validate the proposed changes before integrating them into the codebase.

At block 416, in a code review process, a developer monitoring the Git server 406 reviews the code and merges the submitted PR into branch A₀, resulting in the creation of a new branch A₁. The merge follows standard repository practices, maintaining version history and triggering updates to allow other collaborators to sync to branch A₁. In some cases, reference numeral 414 may also be a push to merge the changes into the code repository. A push in Git is the process of sending local branch commits and their associated changes to the Git server 406, ensuring that the remote branch is updated to match the local state. A push is often done to share work with collaborators, back up progress, or trigger automated build and deployment workflows. The push bypasses a merge process and may be deployed in smaller projects, or review is not necessary.

At reference numeral 418, the client device 402 is configured to send a software development task to the development container 404 to initiate a new software development task based on branch A₁. For example, the software development task can be generating new functions, adding features, validating security checks, updating libraries, and so forth. For purposes of illustration, the development container 404 is requested to add a new feature to the code repository. In some aspects, the operations at reference numeral 418 include configuring and activating a container service to perform the software development task. This can include generating a software development environment that closely mirrors an expected development environment including servers, tooling, configurations, and so forth.

At reference numeral 420, development container 404 is configured to pull branch A₁ into the containerized environment, ensuring runtime versions, libraries, and configurations match those specified in the branch. This allows the automated software development system to operate in the conditions substantially similar to the development environment of the client device 402.

At block 422, development container 404 is configured to modify the branch A₁ from within the containerized environment. For example, the modifications are handled using the same file structure, tooling, and build process available to the developer in client device 402 and ensures that edits are generally indistinguishable in structure and quality from manual edits. In some cases, the development container 404 comprises a container that is network limited (e.g., by disabling the network at the container or by limiting connection at a proxy device) and an AI model can be configured to access the container through an internal interface (e.g., via docker exec), a mounted file system, etc. The development container 404 is also configured to have a terminal service configured with the container to allow input of commands and receive corresponding output.

At reference numeral 424, the development container 404 is configured to submit a PR for branch A₁ to the git server 406. For example, the automated software development system is configured to generate and submit a PR for branch A₁ based on a user's express approval (e.g., at the client device 402 using conventional practices and are therefore not elaborated upon). In some cases, the client device 402 can be configured to submit the PR autonomously or based on review (e.g., by a different AI model). In some cases, the code review can be handled automatically in some cases (e.g., in the case of a solo developer) a push can be submitted in place of the PR, causing the merge to occur.

At block 426, in a code review process, a developer monitoring the Git server 406 reviews the code and merges the submitted PR into branch A₁ during a conventional code review process resulting in the creation of a new branch A₂. The merge follows standard repository practices, maintaining version history and triggering updates to allow other collaborators to sync to branch A₁.

At this point, the development container 404 has completed an iteration to a software development cycle and has updated the repository based on using an AI model in an environment that closely approximates the development container 404. In addition, the AI model is configured to use the additional guidance from the agents metadata file (AGENTS.MD) for guidance, standards, and other information to guide the AI model of the development container 404 in the software development task.

After the development container 404 has completed its assigned task and the corresponding updates have been committed to the repository, the user may access the code repository in the same manner as before, using their preferred development tools and workflows. The modified code is available without requiring any special access procedures or additional integration steps, thereby creating a seamless and frictionless development environment in which automated and manual contributions coexist naturally. This continuity of access streamlines the development cycle and helps build confidence in the automated software development process, as users can directly inspect, test, and extend the AI-generated code within their familiar environment.

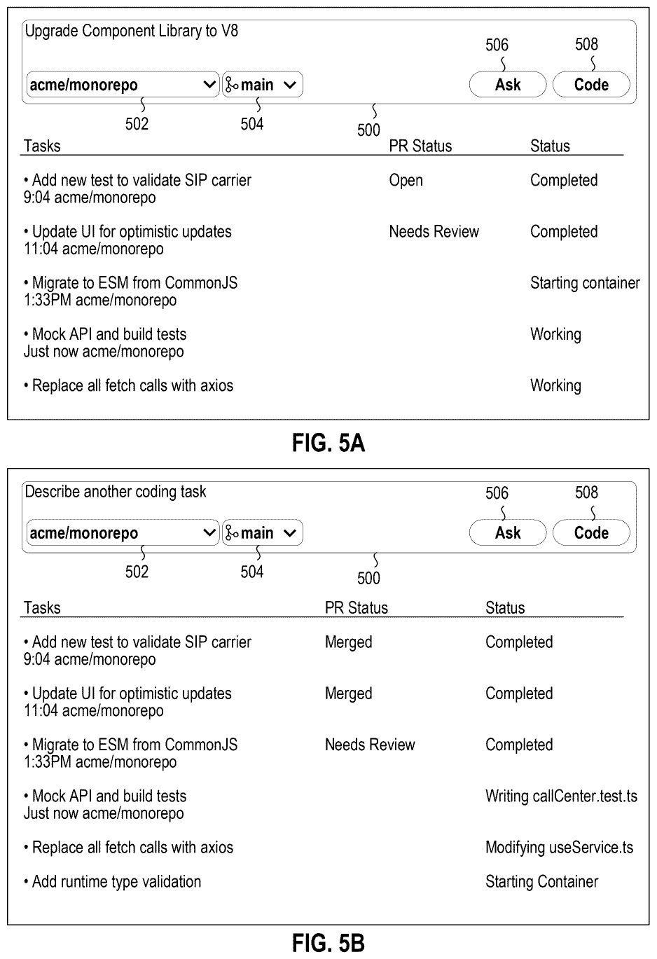

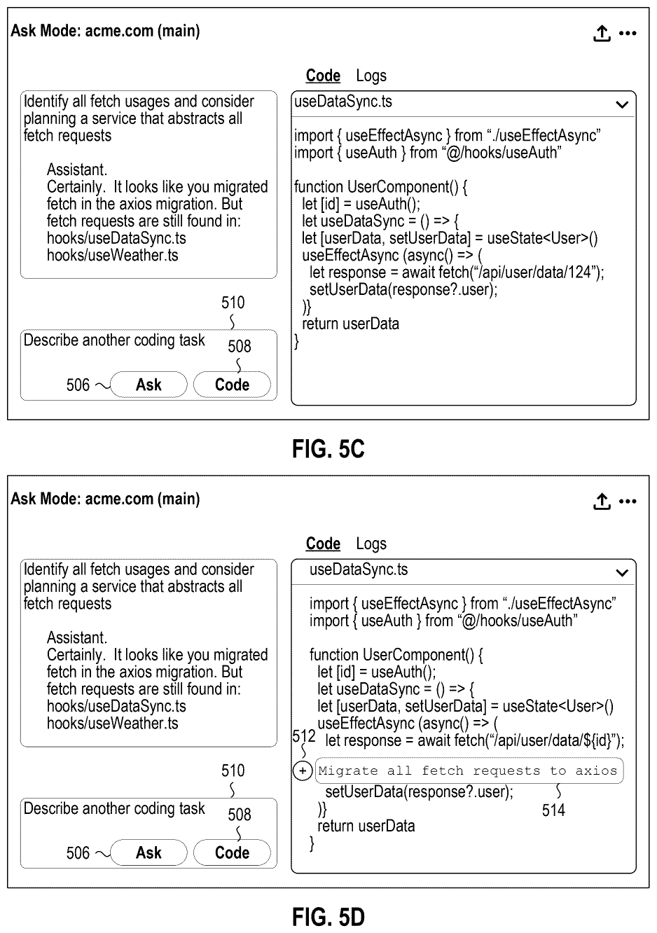

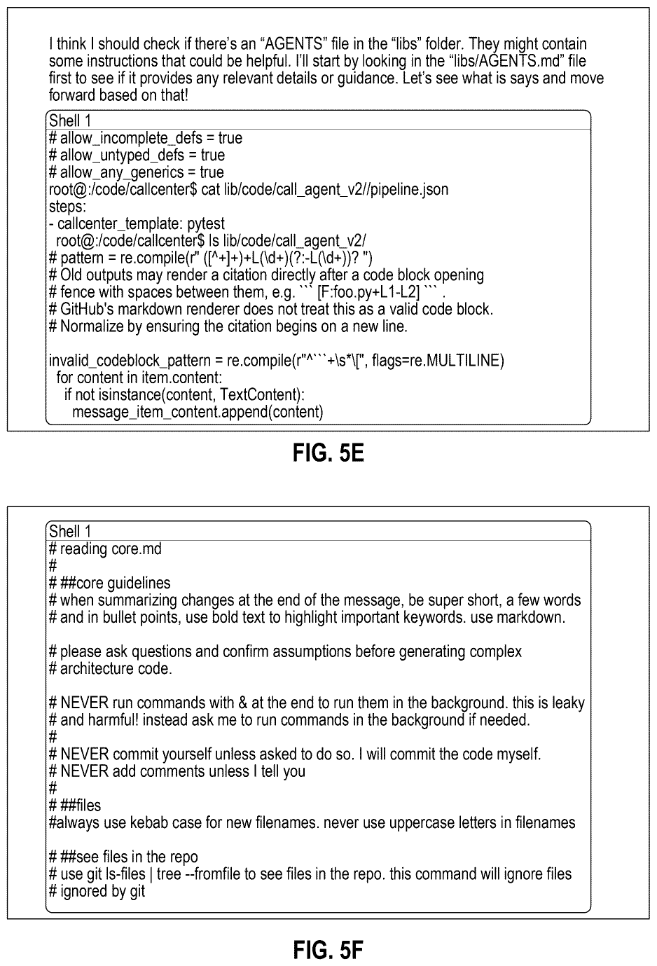

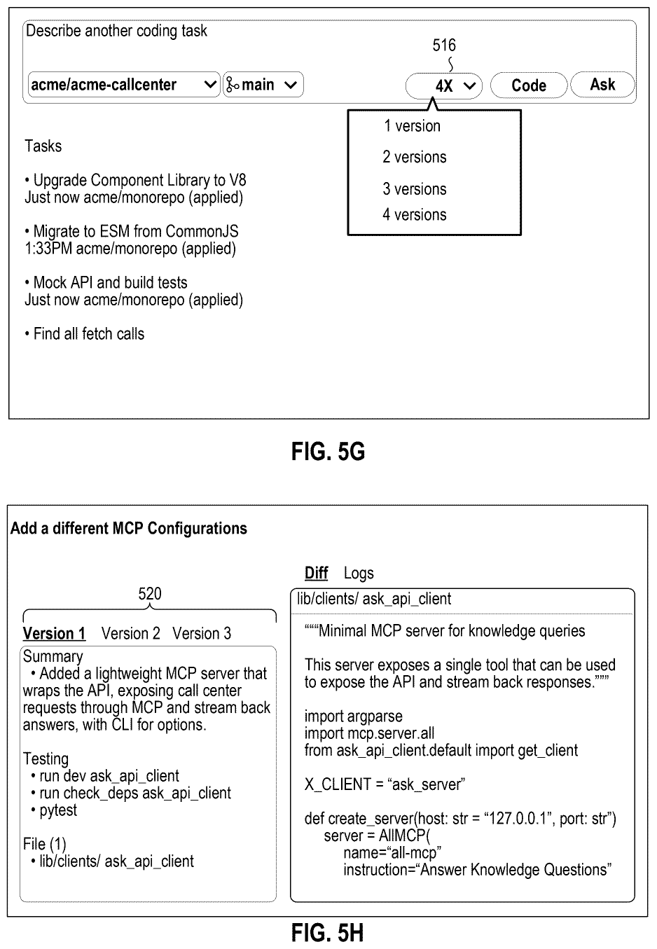

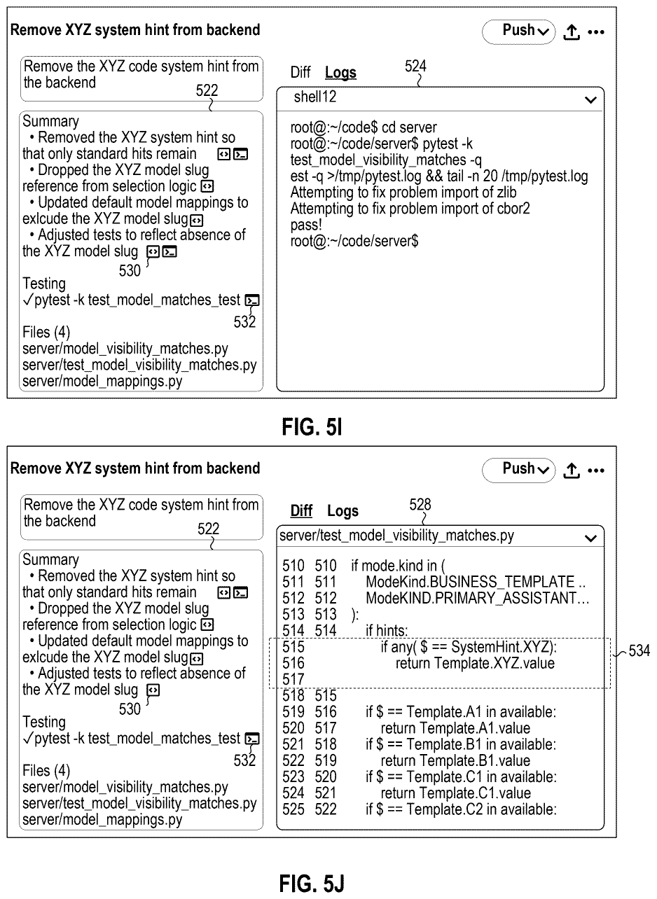

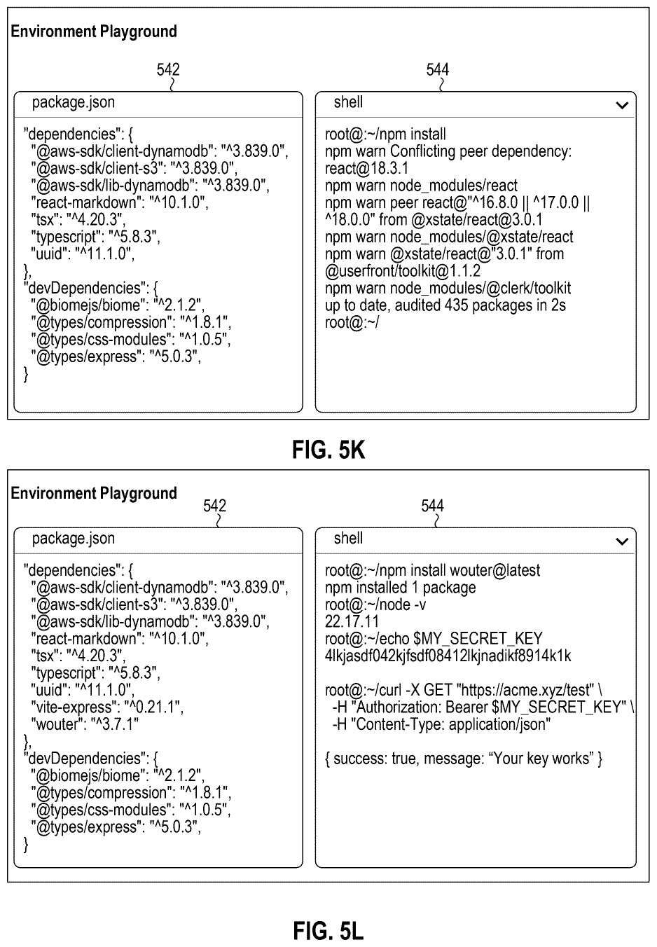

FIG. 5A illustrates an example primary user interface of an automated software development system for inputting and managing software development tasks. In the example shown, the user interface includes an input component 500 for receiving (e.g., via user input) a software development task and various parameters of that task. For example, the input component includes a repository selector 502 and a branch selector 504 to identify the branch within the repository on which the task will operate. The interface also provides different task variants, such as an ask control 506 for prompting for information (e.g., no code modifications) and a code control 508 for performing coding tasks.

The lower portion of the interface displays a task list including both current development tasks and previous tasks. Each task entry includes a description, a timestamp, and the repository context in which it was applied. The example shows a completed task “Migrate to ESM from CommonJS” with its status indicated as Completed, a task “Mock API and build tests” currently in the container that is starting, and a task to replace conventional fetch requests with a more robust library, which is currently marked as working. This arrangement allows the user to view the progress of ongoing automated development operations while also providing a record of recent changes performed by the system.

FIG. 5B illustrates the primary user interface of the automated software development system following the input of a new coding task in the configuration shown in FIG. 5A. In this example, the user has submitted the “Upgrade Component Library to V8” task using the code control 508. Upon submission, the view does not navigate away or require a full page reload. Instead, the interface is updated dynamically, for example, using a reactive front end framework such as React. In such an example, the new task is added to the in-memory task state, and the React component responsible for rendering the task list re-renders only the updated portions of the Document Object Model (DOM).

In this way, the new task appears at the top of the task list with its status set to starting container, while the previously existing tasks remain visible in their prior states. The incremental DOM update ensures that the user maintains a full context of ongoing and completed tasks while adding new ones, eliminating unnecessary UI transitions or reloads. The result is a streamlined and responsive user experience that allows the user to issue multiple tasks in succession and monitor their progress without disrupting workflow. The user experience promotes efficiency and creates a simple, intuitive interaction model in which both new and existing development operations are visible and accessible at all times.

FIG. 5C illustrates an example results view of a completed or in-progress software development task, while still providing the user with immediate access to an input component 510 for adding additional tasks. By displaying the task input area persistently at the bottom of the interface (e.g., including the ask control 506 and the code control 508), the user interface enables the user to seamlessly queue new instructions without navigating away from the current context or losing visibility into prior results. For example, the user interface provides persistent and context-aware input design contributes to a smooth and efficient user experience and allows continuous interaction with the automated development system and supporting rapid iteration without workflow interruptions.

FIG. 5D illustrates an example in which the user is able to annotate code directly within the user interface by selecting a code region and invoking an annotation feature via a control element. In the example shown, the user adds the comment “migrate all fetch requests to axios” within an input control 512 by clicking an add button 514. This capability allows the user to provide targeted, context-specific feedback or instructions without leaving the development interface, enabling the system to capture additional intent or constraints alongside the source code. Such inline annotations offer an efficient mechanism for guiding future automated modifications, documenting decisions, or communicating requirements to collaborators to extending the automated software development system's interactive and collaborative functionality.

FIG. 5E illustrates an example chain-of-thought (CoT) output of the AI model as it interacts with the AGENTS.MD file to obtain additional guidance regarding coding standards, conventions, and other project-specific information. In this example, the AI model reasons that the libs/AGENTS.MD file may contain relevant instructions and proceeds to inspect it, along with other project configuration files, to inform its subsequent actions. The CoT shows step-by-step exploration of directory contents, review of pipeline configurations, and handling of errors when certain files are not found. By incorporating information from the AGENTS.MD file and related resources, the AI model can align its code generation and modifications with team-defined standards, ensuring greater consistency, maintainability, and compliance with project guidelines.

FIG. 5F illustrates an example of an AI model reading an agents file. In this case, the agents.md may be a folder including may different guidelines to help the AI model based on task, with a core task (e.g., core.md) being illustrated in FIG. 5F. The agents file specifies various requirements that the AI model is to follow, such as only using lower kebab case (e.g., lower-kebab-case), how to configure commands, and so forth.

FIG. 5G illustrates an example user interface in which the user can select a “best-of-N” approach for executing a software development task, as shown by the version selector 516. This feature allows the system to generate multiple independent implementations of the same task—such as one, two, three, or four versions—and then present them for comparison. By running several variants in parallel, the user can evaluate alternative approaches for performance, maintainability, or stylistic preference before selecting the optimal result. This process helps identify edge cases, mitigates the risk of a single suboptimal implementation, and can accelerate experimentation with different coding strategies or libraries, ultimately improving the quality and robustness of the delivered solution.

FIG. 5H illustrates an example results interface for the “best-of-N” approach with multiple generated versions of a software development task are presented in a tabbed layout 520 for navigation and review. Each tab corresponds to a distinct implementation to allow the user to quickly switch between versions to compare summaries, testing instructions, file changes, and detailed code diffs. This tabbed organization streamlines evaluation by keeping all variations accessible within a single view, reducing cognitive load and enabling side-by-side consideration of alternative approaches. By making it simple to review, test, and select from multiple candidate solutions, the interface enhances decision-making efficiency and supports higher-quality development outcomes.

FIG. 5I illustrates an example interface of a software development task including a summary 522 and a log interface 524 displaying the results of a test. In this case, the summary 522 includes links to citations such as a code citation 530 and a log citation 532. When a user selects the log citation, the log interface 524 may be displayed illustrating the relevant portions. The citation tokens allow the user to validate the actions taken by the AI model and build extra trust that the task was understood and achieved. Although not shown, citation tokens may be denoted by a Unicode symbol such as lenticular braces. The citation tokens are an inline reference that links a specific command, code change, or output to underlying evidence. In some aspects, citation tokens act as an audit trail to enable users to trace each automated or manual action back to its source. For example, citation tokens can identify a file change (and location), a command execution, or a prior system output. The citation token provides transparency into how and why modifications were made, allowing developers to verify correctness, reproduce results, and maintain accountability throughout the software development process. This audit trail capability is particularly valuable in collaborative and regulated environments where evidentiary records of development activity are important for compliance, debugging, and review.

FIG. 5J illustrates an example interface of a software development task including a summary 522 and a diff interface 528. For example, when a user selects the code citation 530, the diff interface 528 may be displayed in a manner that allows the user to review the code changes. In this case, the AI model revised the code by additional instructions 534, incrementing the line count by three based on the added instructions.

FIG. 5K illustrates an environment playground that allows a user to customize an execution environment associated with their software development tasks. In some aspects, the environment playground includes an edit interface 542 that allows the user to modify aspects of their environment, such as the package file (e.g., package.json) that defines dependencies and development dependencies. For example, the edit interface 542 requires css-modules and biome for development dependencies, which are various tooling used to build the package. The environment playground may include a shell interface 544 to allow a user to modify the package or test the package. For example, in FIG. 5K the user checks whether the project builds by running “npm install” which further checks dependencies. In this case, a warning is output because a package @clerk/toolkit depends on xstate, which requires an older version of the react framework.

FIG. 5L illustrates an environment playground that allows a user to customize an execution environment associated with their software development tasks. In this example, the user performs a first test of installing a new package wouter, which is inserted into the package.json file. The user also performs a second test to validate that the execution environment has a user secret correctly loaded, which is displayed in the shell interface 544. The user then uses the secret key to check the secret against a network request using curl, and inserting the secret key into the authorization header, which returns a success. In this way, the user is able to natively modify an execution environment and test the environment to ensure that the AI model will be using the same tools.

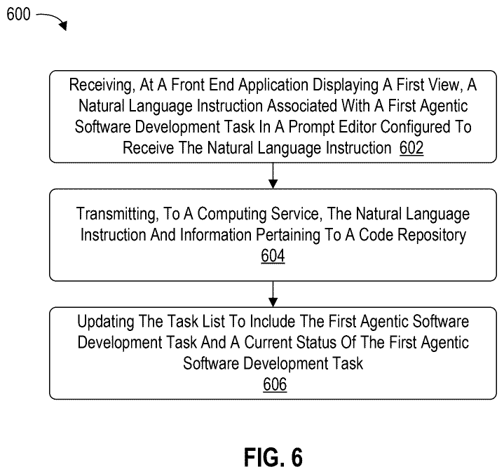

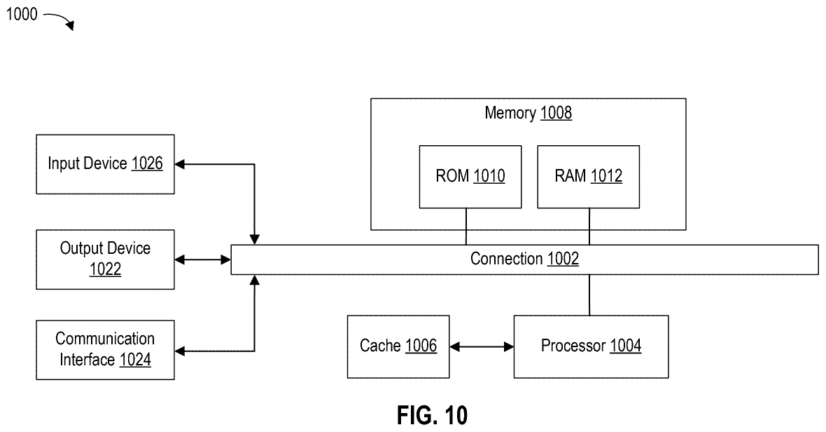

FIG. 6 illustrates a flowchart of process for using a terminal in an agentic software development process in accordance with some aspects of the disclosure. Process 600 (or any other described herein) can be performed by a computing device (or apparatus) or a component (e.g., one or more chipsets, a SoC, one or more processors such as one or more CPUs, GPUs, DSPs, NPUs, NSPs, microcontrollers, ASICs, FPGAs, programmable logic devices, discrete gates or transistor logic components, discrete hardware components, etc., an ML system such as a neural network model, any combination thereof, and/or other component or system) of the computing device. The operations of process 600 may be implemented as software components that are executed and run on one or more processors (e.g., CPU, GPU, DSP, NPU or neural engine, SoC, processor 1004 of FIG. 10, and/or other processor(s)).

In some aspects, the computing system may receive the instructions to perform a software development task and spawn a container based on an execution environment identified by a user configuration. The container process can include a startup configuration which can include retrieving packages associated with a development environment associated with a repository (e.g., code repository 254). For example, the repository may be specified by a user (e.g., a GITHUB repo).

At block 602, the computing system is configured to receive, at a front end application displaying a first view, a natural language instruction associated with a first agentic software development task in a prompt editor configured to receive the natural language instruction, wherein the first view includes a task list. In some cases, the prompt editor may include at least one component for selecting a code repository and an associated branch, and may provide a first input option for generating code and a second input option for generating an answer based on a completed agentic software development task. The first view may also display one or more previously initiated agentic software development tasks, including at least one active task being concurrently developed by an AI model. The prompt editor and task list can be updated without refreshing the first view, enabling the user to maintain continuous visual context while submitting new tasks.

In some implementations, the front end application is a reactive client application executing locally or in a browser-based framework (e.g., React), with dynamic updates to the DOM to incrementally display task state changes without requiring page reloads. This design creates a smooth and responsive user experience by avoiding disruptive navigation or re-rendering cycles, allowing the user to issue multiple tasks in rapid succession and monitor their progress. The persistent prompt editor, which is visible even when viewing past task results, supports a seamless, turn-based development model in which the user can interleave manual development work with automated contributions from the AI model without losing place in the workflow.

At block 604, the computing system is configured to transmit, to a computing service, the natural language instruction and information pertaining to a code repository, wherein the transmitting is effective to initiate the first agentic software development task. In some cases, the information pertaining to the code repository includes a secret key for secure access and the repository itself may contain an agent file (e.g., AGENTS.MD) that provides contextual instructions, style guidelines, and architectural constraints for the AI model. The computing service may spawn a containerized development environment whose configuration (e.g., runtime versions, frameworks, package manager, linters, formatters, and build tools) mirrors the user's local development environment.

In some embodiments, the container environment is configured using environment specifications from the repository and may replicate nuanced local settings such as case sensitivity, TypeScript compiler flags, or linter configurations. This environment mimicry minimizes discrepancies between automated edits and manual developer work, avoiding issues that can arise when code written in an online sandbox is merged into a stricter local IDE. The orchestration engine may enable limited network access during initialization to retrieve required packages from a package repository and then disable or restrict connectivity to prevent malicious activity. This controlled container setup allows the AI model to operate within a realistic, secure environment that faithfully reproduces the developer's workflow conditions, enabling smooth handoffs between human and AI contributors in a turn-based manner.

At block 606, the computing system is configured to update the task list to include the first agentic software development task and a current status of the task. In some implementations, the task list displays multiple agentic software development tasks with respective statuses. The update may occur without refreshing the first view, and may be triggered by receipt of update information from the computing service indicating a second status, including final completion. During the software development task or when the task is completed, a user may select the completed to task to dynamically display a second view summarizing current operations, results, including a diff illustrating changes to files and a log of relevant actions. Both the first and second views may share the same prompt editor and may avoid refreshing to provide a clean and consistent user interface to invoke a new task.

The task list may also support interaction requests from the user to view development data generated by the AI model, such as an inner monologue of reasoning steps, a diff of a text file, or executed commands. While the task is in progress, the system may stream development data to the UI, allowing real-time inspection of the AI's work. Inline annotation features may enable the user to add comments to specific code regions, which can be sent along with a second natural language instruction to initiate follow-up work or answer a query. This integrated display of automated and manual work creates a unified environment where the user can oversee, correct, and extend AI-generated contributions in the same way they would handle a human teammate's work.

In some aspects, the combination of a reactive front end, a containerized execution environment mirroring the user's local setup, and persistent, real-time task tracking produces a frictionless development experience. Developers can alternate between manual changes and automated tasks without context switching, maintaining repository consistency and avoiding environmental mismatches. The system supports a turn-based development paradigm. The user can perform a manual iteration, commit or merge it, and then hand off the next step to the AI model operating in a parallel container instance. Similarly, after the AI completes a task, the user can immediately pull the updated branch into their local environment and continue development. This back-and-forth model leverages the AI's ability to rapidly prototype, refactor, or implement repetitive changes, while preserving the developer's control over higher-level design and final code integration.

By aligning the automated software development system's container environment with the nuances of the local development environment including tooling, configurations, and coding conventions, the system minimizes the risk of code divergence and post-merge integration problems. This mimicry ensures that AI-generated edits compile, lint, and test correctly under the same conditions as the developer's local environment, reducing rework and accelerating the path from idea to production-ready code.

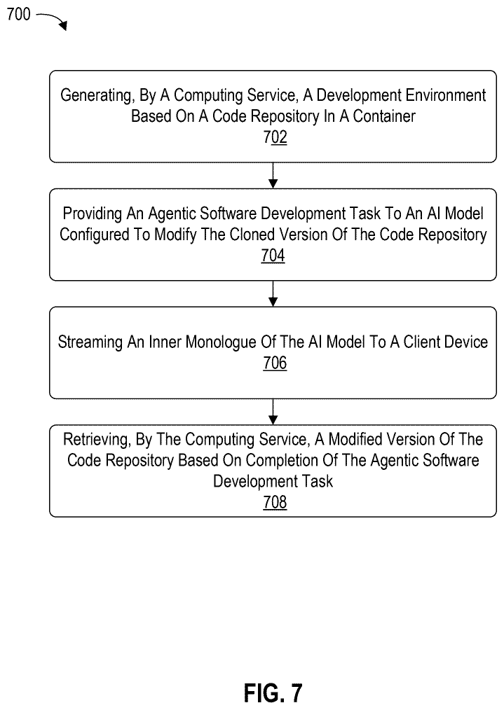

FIG. 7 illustrates a flowchart of process 700 for performing software development tasks using a generative response engine in accordance with some aspects of the disclosure. Process 700 (or any other described herein) can be performed by a computing device (or apparatus) or a component (e.g., one or more chipsets, a SoC, one or more processors such as one or more CPUs, GPUs, DSPs, NPUs, NSPs, microcontrollers, ASICs, FPGAs, programmable logic devices, discrete gates or transistor logic components, discrete hardware components, etc., an ML system such as a neural network model, any combination thereof, and/or other component or system) of the computing device. The operations of process 700 may be implemented as software components that are executed and run on one or more processors (e.g., CPU, GPU, DSP, NPU or neural engine, SoC, processor 1004 of FIG. 10, and/or other processor(s)).

At block 702, the computing service is configured to generate a development environment based on a code repository in a container, wherein the container is configured to mirror a development environment of a user and includes a cloned version of the code repository. In some cases, an orchestration engine provisions a Linux-based container (generally a Linux variant for cost efficiency and deep customization) using repository-supplied specifications (e.g., Dockerfile, package manifests, TypeScript configuration, linter/formatter configs, and project scripts) to align OS, runtime versions, frameworks, tooling, and conventions with the user's local IDE. The container may ingest an agent/metadata file (e.g., Agents.MD) to convey coding standards and architectural guidance, and may initialize with narrowly scoped network access (e.g., allowlisted package registries, scoped domain for API development, etc.) before switching to a restricted or proxy-mediated mode to mitigate misuse. A terminal service can attach a pseudo terminal (PTY) to the container so the back end, and later the AI model, can execute commands and capture byte-stream output while keeping the environment isolated and reproducible.

At block 704, the computing service is configured to provide an agentic software development task to an AI model configured to modify the cloned version of the code repository. In some cases, the task is issued with repository and branch context selected at the front end, along with credentials for private fetches, and the back end mounts or clones the branch into the container to ensure edits are performed “in situ.” The AI model can interact through the terminal service and/or a higher-level file/API surface to read, build, test, lint, and modify source files in the cloned repository. In certain aspects, multiple containers may be spawned in parallel (best-of-N) to explore alternative libraries, refactors, or dependency graphs, with each variant built and tested under substantially identical environmental constraints to the user's local setup.

At block 706, the computing service is configured to stream an inner monologue of the AI model to the front end, wherein the inner monologue identifies discrete actions the AI model is performing to achieve the agentic software development task. In some implementations, the back end emits a real-time event stream that interleaves structured action traces (e.g., “open file,” “apply edit,” “install package,” “run unit tests,” “fix linter rule”), terse rationale tags mapped to those actions, and terminal snapshots (frames with cursor position, text cells, and CSI codes) captured asynchronously from the PTY. The UI renders this as a live “development timeline” next to the task list without refreshing the view, and may include citation tokens that link each discrete action to its evidentiary source (specific file diffs, command output, or logs). Decoupled event loops for model inference, shell execution, and terminal rendering ensure the timeline updates smoothly and the shell remains responsive while the model operates from the latest rendered state.

At block 708, the computing service is configured to retrieve a modified version of the code repository based on completion of the agentic software development task. In some embodiments, a patch engine deterministically derives diffs, commit metadata, and a change proposal (e.g., source branch, target branch, commits, and review descriptors) from the container's filesystem state and command history, and returns them to the front end. The UI then presents a results view with file-level diffs and a log of relevant actions while persisting the prompt editor, enabling the user to approve a pull request or push, queue follow-on tasks, or annotate regions for targeted revisions without navigating away or incurring a full refresh.

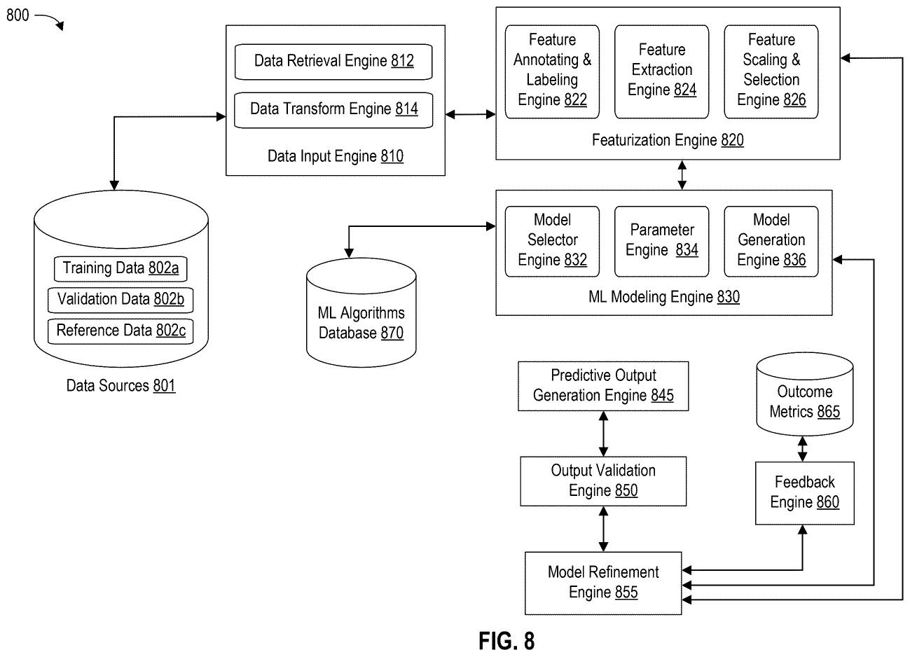

FIG. 8 is a block diagram illustrating an example machine learning platform for implementing various aspects of this disclosure in accordance with some aspects of the present technology. Although the example system depicts particular system components and an arrangement of such components, this depiction is to facilitate a discussion of the present technology and should not be considered limiting unless specified in the appended claims. For example, some components that are illustrated as separate can be combined with other components, and some components can be divided into separate components.

System 800 may include data input engine 810 that can further include data retrieval engine 812 and data transform engine 814. Data retrieval engine 812 may be configured to access, interpret, request, or receive data, which may be adjusted, reformatted, or changed (e.g., to be interpretable by another engine, such as data input engine 810). For example, data retrieval engine 812 may request data from a remote source using an API. Data input engine 810 may be configured to access, interpret, request, format, re-format, or receive input data from data sources(s) 801. For example, data input engine 810 may be configured to use data transform engine 814 to execute a re-configuration or other change to data, such as a data dimension reduction. In some aspects, data sources(s) 801 may be associated with a single entity (e.g., organization) or with multiple entities. Data sources(s) 801 may include one or more of training data 802a (e.g., input data to feed a machine learning model as part of one or more training processes), validation data 802b (e.g., data against which at least one processor may compare model output with, such as to determine model output quality), and/or reference data 802c. In some aspects, data input engine 810 can be implemented using at least one computing device. For example, data from data sources(s) 801 can be obtained through one or more I/O devices and/or network interfaces. Further, the data may be stored (e.g., during execution of one or more operations) in a suitable storage or system memory. Data input engine 810 may also be configured to interact with a data storage, which may be implemented on a computing device that stores data in storage or system memory.

System 800 may include featurization engine 820. Featurization engine 820 may include feature annotating & labeling engine 822 (e.g., configured to annotate or label features from a model or data, which may be extracted by feature extraction engine 824), feature extraction engine 824 (e.g., configured to extract one or more features from a model or data), and/or feature scaling & selection engine 826 Feature scaling & selection engine 826 may be configured to determine, select, limit, constrain, concatenate, or define features (e.g., AI features) for use with AI models.

System 800 may also include ML modeling engine 830, which may be configured to execute one or more operations on a machine learning model (e.g., model training, model re-configuration, model validation, model testing), such as those described in the processes described herein. For example, ML modeling engine 830 may execute an operation to train a machine learning model, such as adding, removing, or modifying a model parameter. Training of a machine learning model may be supervised, semi-supervised, or unsupervised. In some aspects, training of a machine learning model may include multiple epochs, or passes of data (e.g., training data 802a) through a machine learning model process (e.g., a training process). In some aspects, different epochs may have different degrees of supervision (e.g., supervised, semi-supervised, or unsupervised). Data into a model to train the model may include input data (e.g., as described above) and/or data previously output from a model (e.g., forming a recursive learning feedback). A model parameter may include one or more of a seed value, a model node, a model layer, an algorithm, a function, a model connection (e.g., between other model parameters or between models), a model constraint, or any other digital component influencing the output of a model. A model connection may include or represent a relationship between model parameters and/or models, which may be dependent or interdependent, hierarchical, and/or static or dynamic. The combination and configuration of the model parameters and relationships between model parameters discussed herein are cognitively infeasible for the human mind to maintain or use. Without limiting the disclosed aspects in any way, a machine learning model may include millions, billions, or even trillions of model parameters. ML modeling engine 830 may include model selector engine 832 (e.g., configured to select a model from among a plurality of models, such as based on input data), parameter engine 834 (e.g., configured to add, remove, and/or change one or more parameters of a model), and/or model generation engine 836 (e.g., configured to generate one or more machine learning models, such as according to model input data, model output data, comparison data, and/or validation data).

In some aspects, model selector engine 832 may be configured to receive input and/or transmit output to ML algorithms database 870. Similarly, featurization engine 820 can utilize storage or system memory for storing data and can utilize one or more I/O devices or network interfaces for transmitting or receiving data. ML algorithms database 870 may store one or more machine learning models, any of which may be fully trained, partially trained, or untrained. A machine learning model may be or include, without limitation, one or more of (e.g., such as in the case of a metamodel) a statistical model, an algorithm, a neural network (NN), a convolutional neural network (CNN), a generative neural network (GNN), a Word2Vec model, a bag of words model, a term frequency-inverse document frequency (tf-idf) model, a GPT (Generative Pre-trained Transformer) model (or other autoregressive model), a diffusion model, a diffusion-transformer model, an encoder such as BERT (Bidirectional Encoder Representations from Transformers) or LXMERT (Learning Cross-Modality Encoder Representations from Transformers), a Proximal Policy Optimization (PPO) model, a nearest neighbor model (e.g., k nearest neighbor model), a linear regression model, a k-means clustering model, a Q-Learning model, a Temporal Difference (TD) model, a Deep Adversarial Network model, or any other type of model described further herein. Some of the ML algorithms in ML algorithms database 870 can be considered generative response engines. Generative response engines are those models are commonly referred to as Generative AI, and that can receive an input prompt and generate additional content based on the prompt. GPTs, diffusion models, and diffusion-transformer models are some non-limiting examples of generative response engines. Some specific examples of generative response engines that can be stored in the ML algorithms database 870 include versions DALL·E, CHAT GPT, and SORA, all provided by OPEN AI.

System 800 can further include predictive output generation engine 845 and output validation engine 850 (e.g., configured to apply validation data to machine learning model output). Predictive output generation engine 845 can analyze the input and identify relevant patterns and associations in the data it has learned to generate a sequence of words that predictive output generation engine 845 predicts is the most likely continuation of the input using one or more models from the ML algorithms database 870, aiming to provide a coherent and contextually relevant answer. Predictive output generation engine 845 generates responses by sampling from the probability distribution of possible words and sequences, guided by the patterns observed during its training. In some aspects, predictive output generation engine 845 can generate multiple possible responses before presenting the final one. Predictive output generation engine 845 can generate multiple responses based on the input, and these responses are variations that predictive output generation engine 845 considers potentially relevant and coherent. Output validation engine 850 can evaluate these generated responses based on certain criteria. These criteria can include relevance to the prompt, coherence, fluency, and sometimes adherence to specific guidelines or rules, depending on the application. Based on this evaluation, output validation engine 850 selects the most appropriate response. This selection is typically the one that scores highest on the set criteria, balancing factors like relevance, informativeness, and coherence.

System 800 can further include feedback engine 860 (e.g., configured to apply feedback from a user and/or machine to a model) and model refinement engine 855 (e.g., configured to update or re-configure a model). In some aspects, feedback engine 860 may receive input and/or transmit output (e.g., output from a trained, partially trained, or untrained model) to outcome metrics database 865. Outcome metrics database 865 may be configured to store output from one or more models and may also be configured to associate output with one or more models. In some aspects, outcome metrics database 865, or other device (e.g., model refinement engine 855 or feedback engine 860), may be configured to correlate output, detect trends in output data, and/or infer a change to input or model parameters to cause a particular model output or type of model output. In some aspects, model refinement engine 855 may receive output from predictive output generation engine 845 or output validation engine 850. In some aspects, model refinement engine 855 may transmit the received output to featurization engine 820 or ML modeling engine 830 in one or more iterative cycles.

The engines of system 800 may be packaged functional hardware units designed for use with other components or a part of a program that performs a particular function (e.g., of related functions). Any or each of these modules may be implemented using a computing device. In some aspects, the functionality of system 800 may be split across multiple computing devices to allow for distributed processing of the data, which may improve output speed and reduce computational load on individual devices. In some aspects, system 800 may use load-balancing to maintain stable resource load (e.g., processing load, memory load, or bandwidth load) across multiple computing devices and to reduce the risk of a computing device or connection becoming overloaded. In these or other aspects, the different components may communicate over one or more I/O devices and/or network interfaces.

System 800 can be related to different domains or fields of use. Descriptions of aspects related to specific domains, such as natural language processing or language modeling, is not intended to limit the disclosed aspects to those specific domains, and aspects consistent with the present disclosure can apply to any domain that utilizes predictive modeling based on available data.

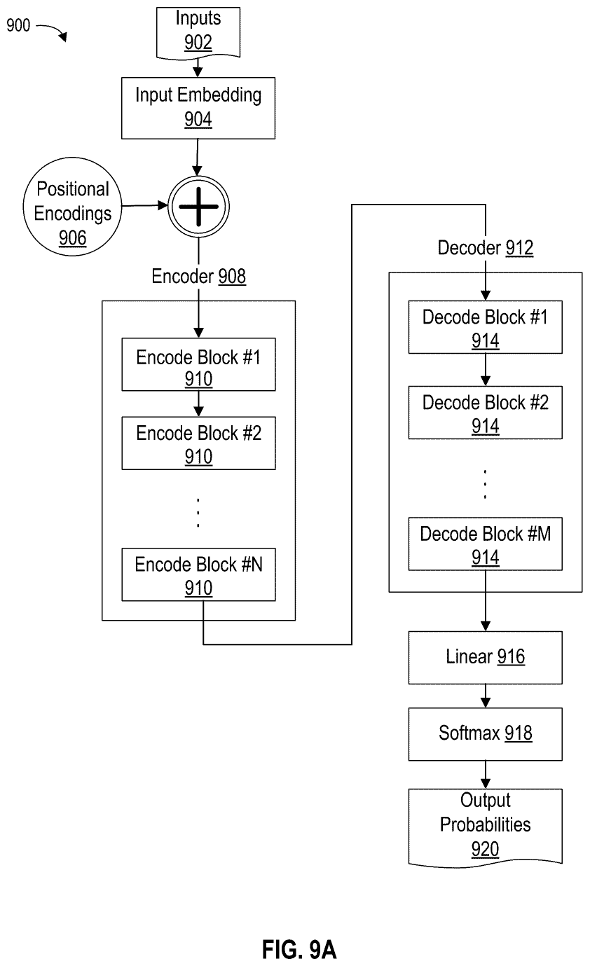

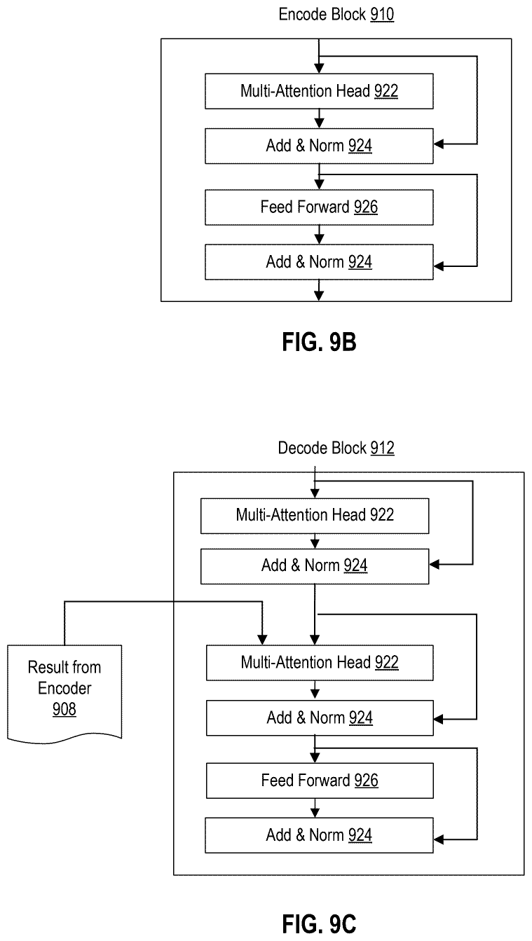

FIG. 9A, FIG. 9B, and FIG. 9C illustrates an example transformer architecture in accordance with some aspects of the present technology. Examples of ML models that use a transformer neural network (e.g., transformer architecture 900) can include, e.g., generative pretrained transformer (GPT) models and Bidirectional Encoder Representations from Transformer (BERT) models. The transformer architecture 900, which is illustrated in FIG. 9A, FIG. 9B, and FIG. 9C, includes inputs 902, input embedding block 904, positional encodings 906, encoder 908 including encode blocks 910, decoder 912 including decode blocks 914, linear block 916, softmax block 918, and output probabilities 920.

Input embedding block 904 is used to provide representations for words. For example, embedding can be used in text analysis. According to certain non-limiting examples, the representation is a real-valued vector that encodes the meaning of the word in such a way that words that are closer in the vector space are expected to be similar in meaning. Word embeddings can be obtained using language modeling and feature learning techniques, where words or phrases from the vocabulary are mapped to vectors of real numbers. According to certain non-limiting examples, the input embedding block 904 can be learned embeddings to convert the input tokens and output tokens to vectors of dimension that have the same dimension as the positional encodings, for example.

Positional encodings 906 provide information about the relative or absolute position of the tokens in the sequence. According to certain non-limiting examples, positional encodings 906 can be provided by adding positional encodings to the input embeddings at the inputs to the encoder 908 and decoder 912. The positional encodings have the same dimension as the embeddings, thereby enabling a summing of the embeddings with the positional encodings. There are several ways to realize the positional encodings, including learned and fixed. For example, sine and cosine functions having different frequencies can be used. That is, each dimension of the positional encoding corresponds to a sinusoid. Other techniques of conveying positional information can also be used, as would be understood by a person of ordinary skill in the art. For example, learned positional embeddings can instead be used to obtain similar results. An advantage of using sinusoidal positional encodings rather than learned positional encodings is that doing so allows the model to extrapolate to sequence lengths longer than the ones encountered during training.

Encoder 908 can use stacked self-attention and point-wise, fully connected layers. Encoder 908 can be a stack of N identical layers (e.g., N=6), and each layer can be an encode block, as illustrated by encode block 910 shown in FIG. 9B. Each encode block 910 has two sub-layers: (i) a first sub-layer has a multi-head attention block 922 and (ii) a second sub-layer has a feed forward block 926, which can be a position-wise fully connected feed-forward network. The feed forward block 926 can use a rectified linear unit (ReLU).

Encoder 908 uses a residual connection around each of the two sub-layers, followed by an add & norm block 924, which performs normalization. For example, the output of each sub-layer can be LayerNorm(x+Sublayer(x)). To facilitate these residual connections, all sub-layers in the model, as well as the embedding layers, produce output data having a same dimension.

Similar to encoder 908, decoder 912 uses stacked self-attention and point-wise, fully connected layers. Decoder 912 can also be a stack of M identical layers (e.g., M=6), and each layer can be a decode block, as illustrated by decoder 912 shown in FIG. 9B. In addition to the two sub-layers (i.e., the sublayer with multi-head attention block 922 and the sub-layer with feed forward block 926) found in encode block 910, decode block 914 can include a third sub-layer, which performs multi-head attention over the output of the encoder stack. Similar to encoder 908, decoder 912 uses residual connections around each of the sub-layers, followed by layer normalization. Additionally, the sub-layer with multi-head attention block 922 can be modified in the decoder stack to prevent positions from attending to subsequent positions. This masking, combined with the fact that the output embeddings are offset by one position, can ensure that the predictions for position i can depend only on the known output data at positions less than i.

Linear block 916 can be a learned linear transformation. For example, when transformer architecture 900 is being used to translate from a first language into a second language, linear block 916 can project the output from the last decode softmax block 918 into word scores for the second language (e.g., a score value for each unique word in the target vocabulary) at each position in the sentence. For instance, if the output sentence has seven words and the provided vocabulary for the second language has 10,000 unique words, then 10,000 score values are generated for each of those seven words. The score values indicate the likelihood of occurrence for each word in the vocabulary in that position of the sentence.

Softmax block 918 then turns the scores from linear block 916 into output probabilities 920 (which add up to 1.0). In each position, the index provides for the word with the highest probability, and then maps that index to the corresponding word in the vocabulary. Those words then form the output sequence of transformer architecture 900. The softmax operation is applied to the output from linear block 916 to convert the raw numbers into output probabilities 920 (e.g., token probabilities).

FIG. 10 shows an example of computing system 1000, which can be, for example, any computing device making up any engine illustrated in FIG. 1 or any component thereof.

In some aspects, computing system 1000 is a single device, or a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

In some aspects, computing system 1000 may comprise one or more computing resources provisioned from a “cloud computing” provider, For example, AMAZON ELASTIC COMPUTE CLOUD (“AMAZON EC2”), provided by AMAZON, INC. of Seattle, Washington; SUN CLOUD COMPUTER UTILITY, provided by SUN MICROSYSTEMS, INC. of Santa Clara, California; AZURE, provided by MICROSOFT CORPORATION of Redmond, Washington, GOOGLE CLOUD PLATFORM, provided by ALPHABET, INC. of Mountain View, California, and the like.

Example computing system 1000 includes at least one processing unit (CPU or processor) 1004 and connection 1002 that couples various system components including system memory 1008, such as read-only memory (ROM) 1010 and random access memory (RAM) 1012 to processor 1004. Memory 1008 can be a volatile or non-volatile memory device, and can be a hard disk or other types of non-transitory computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

Memory 1008 can include software services, servers, logic, etc., that when the code that defines such software is executed by the processor 1004, it causes the system to perform a function. In some aspects, a hardware service that performs a particular function can include the software component stored in a computer-readable medium in connection with the necessary hardware components, such as processor 1004, connection 1002, output device 1022, etc., to carry out the function.

Computing system 1000 can include a cache of high-speed memory 1006 connected directly with, in close proximity to, or integrated as part of processor 1004.

Connection 1002 can be a physical connection via a bus, or a direct connection into processor 1004, such as in a chipset architecture. Connection 1002 can also be a virtual connection, networked connection, or logical connection.

Processor 1004 can include any general purpose processor and a hardware service or software service stored in memory 1008, configured to control processor 1004 as well as a special-purpose processor where software instructions are incorporated into the actual processor design. Processor 1004 may essentially be a completely self-contained computing system, containing multiple cores or processors, a bus, memory controller, cache, etc. A multi-core processor may be symmetric or asymmetric. Processor 1004 can be physical or virtual.

To enable user interaction, computing system 1000 includes an input device 1026, which can represent any number of input mechanisms, such as a microphone for speech, a touch-sensitive screen for gesture or graphical input, keyboard, mouse, motion input, speech, etc. Computing system 1000 can also include output device 1022, which can be one or more of a number of output mechanisms known to those of skill in the art. In some instances, multimodal systems can enable a user to provide multiple types of input/output to communicate with computing system 1000. Computing system 1000 can include communication interface 1024, which can generally govern and manage the user input and system output. There is no restriction on operating on any particular hardware arrangement, and therefore the basic features here may easily be substituted for improved hardware or firmware arrangements as they are developed.

In some aspects, computing system 1000 can refer to a combination of a personal computing device interacting with components hosted in a data center, where both the computing device and the components in the data center. In such examples, both the personal computing device and the components in the datacenter might have a processor, cache, memory, storage, etc.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, For example, instructions and data which cause or otherwise configure a general purpose computer, special purpose computer, or special purpose processing device to perform a certain function or group of functions. Portions of computer resources used can be accessible over a network. The executable computer instructions may be, For example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

The present technology includes computer-readable storage mediums for storing instructions, and systems for executing any one of the methods embodied in the instructions addressed in the aspects of the present technology presented below:

Aspect 1. A method, comprising: receiving, at a front end application displaying a first view, a natural language instruction associated with a first agentic software development task in a prompt editor configured to receive the natural language instruction, wherein the first view includes a task list; transmitting, to a computing service, the natural language instruction and information pertaining to a code repository, wherein the transmitting the natural language instruction is effective to initiate the first agentic software development task; and updating the task list to include the first agentic software development task and a current status of the first agentic software development task.

Aspect 2. The method of Aspect 1, wherein updating the task list does not refresh the first view.

Aspect 3. The method of any of Aspects 1 to 2, wherein the prompt editor of the first view includes at least one component for selecting the code repository and a branch associated with the code repository.

Aspect 4. The method of any of Aspects 1 to 3, wherein previous agentic software development tasks includes at least one active software development task that an AI model is concurrently developing when the natural language instruction is transmitted to the computing service.

Aspect 5. The method of any of Aspects 1 to 4, wherein the information pertaining to the code repository includes information associated with a secret key to access the code repository.

Aspect 6. The method of any of Aspects 1 to 5, further comprising: receiving information from the computing service indicating the first agentic software development task is completed, wherein the task list is updated to reflect the first agentic software development task is completed without refreshing the first view.

Aspect 7. The method of any of Aspects 1 to 6, further comprising: displaying a second view illustrating a summary of the first agentic software development task illustrating changes made to complete the natural language instruction, wherein the summary comprises a diff illustrating changes to at least one file and a log associated with relevant actions to complete the natural language instruction.

Aspect 8. The method of Aspect 7, wherein the first view and the second view include the prompt editor for receiving the natural language instruction.

Aspect 9. The method of Aspect 8, wherein the first view and the second view do not refresh when a second agentic software development task input into the prompt editor is sent to the computing service.

Aspect 10. The method of any of Aspects 1 to 9, wherein the prompt editor comprises a first input option associated with generating code and a second input option associated with generating an answer based on a completed agentic software development task.

Aspect 11. The method of any of Aspects 1 to 10, further comprising: receiving, from the computing service, update information associated with a second status of the first agentic software development task; and updating the first agentic software development task in the task list to display the second status of the first agentic software development task.

Aspect 12. The method of any of Aspects 1 to 11, further comprising: receiving, at the front end application, a request to interact with the first agentic software development task; and displaying development data generated by an AI model in connection with the first agentic software development task.

Aspect 13. The method of Aspect 12, wherein the development data includes at least one of an inner monologue associated with a discrete task the AI model identified as part of the natural language instruction, a diff associated with a text file, and a command executed by the AI model.

Aspect 14. The method of Aspect 13, further comprising: receive, at the front end application, a comment associated with the development data; and transmitting, to the computing service, a second natural language instruction and the comment, wherein the transmitting the natural language instruction is effective to initiate a second agentic software development task or respond to a query based on the comment.

Aspect 15. The method of any of Aspects 1 to 14, further comprising: receiving, at the front end application, a request to interact with the first agentic software development task while an AI model is performing the first agentic software development task; receiving a stream of development data associated with the first agentic software development task while the AI model is performing the first agentic software development task; and displaying the stream of development data in connection with the first agentic software development task.

Aspect 16. The method of any of Aspects 1 to 15, wherein the code repository includes an agent file that provides context and instructions to an AI model in connection with the first agentic software development task.

Aspect 17. The method of any of Aspects 1 to 16, wherein a container is configured based on an environment and libraries defined by the code repository to mirror a local development environment.

Aspect 18. The method of any of Aspects 1 to 17, wherein the task list includes a plurality of agentic software development tasks and a status of a respective agentic software development task.

Aspect 19. A method comprising: generating, by a computing service, a development environment based on a code repository in a container, wherein the container is configured to mirror a customized development environment configured by a user and includes a cloned version of the code repository; providing an agentic software development task to an AI model configured to modify the cloned version of the code repository; streaming an inner monologue of the AI model to a client device, wherein the inner monologue identifies discrete actions the AI model is performing to achieve the agentic software development task; and retrieving, by the computing service, a modified version of the code repository based on completion of the agentic software development task.

What is claimed is:

1. A method, comprising:
receiving, at a front end application displaying a first view, a natural language instruction associated with a first agentic software development task in a prompt editor configured to receive the natural language instruction, wherein the first view includes a task list;
transmitting, to a computing service, the natural language instruction and information pertaining to a code repository, wherein the transmitting the natural language instruction is effective to initiate the first agentic software development task; and
updating the task list to include the first agentic software development task and a current status of the first agentic software development task.

2. The method of claim 1, wherein updating the task list does not refresh the first view.

3. The method of claim 1, wherein the prompt editor of the first view includes at least one component for selecting the code repository and a branch associated with the code repository.

4. The method of claim 1, wherein previous agentic software development tasks includes at least one active software development task that an AI model is concurrently developing when the natural language instruction is transmitted to the computing service.

5. The method of claim 1, wherein the information pertaining to the code repository includes information associated with a secret key to access the code repository.

6. The method of claim 1, further comprising:
receiving information from the computing service indicating the first agentic software development task is completed, wherein the task list is updated to reflect the first agentic software development task is completed without refreshing the first view.

7. The method of claim 1, further comprising:
displaying a second view illustrating a summary of the first agentic software development task illustrating changes made to complete the natural language instruction, wherein the summary comprises a diff illustrating changes to at least one file and a log associated with relevant actions to complete the natural language instruction.

8. The method of claim 7, wherein the first view and the second view include the prompt editor for receiving the natural language instruction.

9. The method of claim 8, wherein the first view and the second view do not refresh when a second agentic software development task input into the prompt editor is sent to the computing service.

10. The method of claim 1, wherein the prompt editor comprises a first input option associated with generating code and a second input option associated with generating an answer based on a completed agentic software development task.

11. The method of claim 1, further comprising:
receiving, from the computing service, update information associated with a second status of the first agentic software development task; and
updating the first agentic software development task in the task list to display the second status of the first agentic software development task.

12. The method of claim 1, further comprising:
receiving, at the front end application, a request to interact with the first agentic software development task; and
displaying development data generated by an AI model in connection with the first agentic software development task.

13. The method of claim 12, wherein the development data includes at least one of an inner monologue associated with a discrete task the AI model identified as part of the natural language instruction, a diff associated with a text file, and a command executed by the AI model.

14. The method of claim 13, further comprising:
receive, at the front end application, a comment associated with the development data; and
transmitting, to the computing service, a second natural language instruction and the comment, wherein the transmitting the natural language instruction is effective to initiate a second agentic software development task or respond to a query based on the comment.

15. The method of claim 1, further comprising:
receiving, at the front end application, a request to interact with the first agentic software development task while an AI model is performing the first agentic software development task;
receiving a stream of development data associated with the first agentic software development task while the AI model is performing the first agentic software development task; and
displaying the stream of development data in connection with the first agentic software development task.

16. The method of claim 1, wherein the code repository includes an agent file that provides context and instructions to an AI model in connection with the first agentic software development task.

17. The method of claim 1, wherein a container is configured based on an environment and libraries defined by the code repository to mirror a local development environment.

18. The method of claim 1, wherein the task list includes a plurality of agentic software development tasks and a status of a respective agentic software development task.

19. A method comprising:
generating, by a computing service, a development environment based on a code repository in a container, wherein the container is configured to mirror a customized development environment configured by a user and includes a cloned version of the code repository;
providing an agentic software development task to an AI model configured to modify the cloned version of the code repository;
streaming an inner monologue of the AI model to a client device, wherein the inner monologue identifies discrete actions the AI model is performing to achieve the agentic software development task; and
retrieving, by the computing service, a modified version of the code repository based on completion of the agentic software development task.

20. A computing device for performing a function, comprising:
at least one memory; and
at least one processor coupled to the at least one memory and configured to:
receive, at a front end application displaying a first view, a natural language instruction associated with a first agentic software development task in a prompt editor configured to receive the natural language instruction, wherein the first view includes a task list;
transmit, to a computing service, the natural language instruction and information pertaining to a code repository, wherein the transmitting the natural language instruction is effective to initiate the first agentic software development task; and
update the task list to include the first agentic software development task and a current status of the first agentic software development task.
